(19) United States
(12) Patent Application Publication
(10) Pub. No.: US 2016/0044429 A1
(43) Pub. Date: Feb. 11, 2016

(54) COMPUTING DEVICE IDENTIFICATION USING DEVICE-SPECIFIC DISTORTIONS OF A DISCONTINUOUS AUDIO WAVEFORM

(71) Applicant: InAuth, Inc., Venice, CA (US)

(72) Inventor: Brian Lee Moffat, Simi Valley, CA (US)

(21) Appl. No.: 14/796,954

(22) Filed: Jul. 10, 2015

Related U.S. Application Data
(60) Provisional application No. 62/023,093, filed on Jul. 10, 2014.

(51) Int. Cl. H04R 29/00; G01H 17/00

(52) U.S. Cl. CPC H04R 29/00; G01H 17/00

(57) ABSTRACT

Disclosed is a novel technique and method for determining a device-unique signature capable of accurately identifying a particular mobile phone, tablet, or other personal computing device

### RELATED APPLICATIONS

This application claims benefit of priority to Provisional U.S. Patent Application No. 62/023,093, which is incorporated herein by Reference in its respective entirety.

### TECHNICAL FIELD

Examples herein provide for a personal computing device identification system that utilizes a source audio waveform that contains one or more discontinuities.

### BACKGROUND

Devices are known which play and/or record sounds with known frequencies and amplitudes and use magnitudes (relative and/or absolute) as a basis for device-specific signature-based ID. However, this requires user/operator patience as sounds are played and recorded.

A typical method of measuring relative amplitudes is via FFT. However, while probability of pollution by background noise increases with increases in the duration of sound(s), the resolution of FFT decreases with decreases in the duration of the sound(s).

A discontinuous source audio specifies infinite harmonic series at equally-spaced frequencies.

A speaker (and associated electronics) cannot produce all frequencies of frequencies that it can potentially produce, the amplitudes vary from the ideal of (I/h) pattern of frequency-specific variation is unique to a device. Variations in amplitudes (including amplitudes of zero where they should be non-zero) create an actual output that manifests as a sound ring pattern that is unique to a device because the variations that lead to ringing are unique to the device. The unique ringing sound causes microphones (and associated electronics) to record amplitudes which differ from actual amplitudes of frequencies within ring pattern. The pattern of variation between actual frequencies in ring sound and those recorded is unique to a device. The unique variations of recording, superimposed on unique ring frequencies generated, provides a unique signature for a device.

More and more people interact with the Internet, and with the data and services available therein, by personal computing devices. It is often, if not usually, the case that each of these personal computing devices is used exclusively by one particular person. And, it is often, if not usually, the case that any particular person will interact with the Internet predominantly, if not exclusively, by a particular personal computing device. In other words, there is typically a one-to-one correspondence between a particular person and a particular personal computing device.

Many of the interactions that people execute by or via the Internet involve the transfer of tangible and/or intangible items of value to, from, and/or between, accounts, deposits, repositories, and/or other storage media, belonging to and/or controlled by a particular person and/or by a particular company or corporation, by computing devices utilizing instructions as well as data which is transmitted to particular servers, often accessed at particular URL's and/or IP addresses. Because communications and/or transactions executed across or via the internet are digital and composed of, and/or specified with, digital values that are atomic and fungible, it has been possible for criminals to access the accounts of others and, by impersonating those others and/or their account-access credentials, to manipulate the relevant server(s) so as to steal, or cause to be stolen, their items of value.

Many of the thefts perpetrated through the impersonation of account holders, and/or through the submission of illegally obtained account credentials, could have been thwarted had the servers, and/or the software thereon, responsible for controlling access to the violated accounts been able to accurately identify the particular personal computing device that was used to request, initiate, execute, and/or control, the fraudulent transactions. Such a capability would have allowed those servers, and/or the software thereon, to recognize that the personal computing devices being used to request, initiate, execute, and/or control, those transactions were not the devices that had typically, if not exclusively, been used in the past by the legitimate holders of those vandalized accounts to request, initiate, execute, and/or control, their account transactions. If those servers, and/or the software thereon, had been able to recognize that an attempt was being made to access, and/or to make a withdrawal from, an account by a personal computing device that had not been used in the past to request, initiate, execute, and/or control transactions involving that account, then those servers, and/or the software thereon, would have had been able to determine that those transactions were “suspicious” and on that basis to block, or at least to better vet them.

While servers, and/or the software thereon, have historically used self-reported values such as a computing device's “MAC address” to establish the identity of a device, such self-reported identifiers can be faked, and, as is the case with Apple™ Computer's iOS™ versions 7 and 8, they are not always available. Therefore, there is, and has been, a need for an independent and reliable system and method of unambiguously identifying an internet user's personal computing device in a manner, and by a method, that is difficult, if not impossible, for a thief to undermine, duplicate, and/or fake.

### BRIEF DESCRIPTION OF THE DRAWINGS

FIG. 1A is an illustration of a representative block diagram of a sound-generation system for a computing device, according to one or more examples.

FIG. 1B is an illustration of a representative block diagram of a sound-recording device, according to one or more examples.

FIG. 1C is an illustration of a representative block diagram of a sound-generation and recording system for use with a computing device, according to one or more examples.

FIG. 2A is a definition of an ideal square wave for use with examples described herein.

FIG. 2B is a definition of an ideal sawtooth wave for use with examples described herein.

FIG. 2C illustrates a variety of periodic functions that include “hard” discontinuities.

FIGS. 2D-2J illustrate other examples of various functions which include “hard” discontinuities.

FIGS. 3A through 3C are examples of periodic functions that include “soft” discontinuities.

FIG. 4A illustrates the superposition of a “fundamental” sine wave with a 3rd harmonic.

FIG. 4B illustrates the superposition of a “fundamental” sine wave with respective 3^{rd} and 5^{th} harmonics.

FIG. 4C illustrates a progressive superposition of a “fundamental” sine wave with an increasing number of its harmonics.

FIG. 4D illustrates a step-wise progressive superposition of a “fundamental” sine wave with an increasing number of its harmonics.

FIG. 5 illustrates an example square wave (and the discontinuities therein) which can be used as a basis for generation of audio by a personal computing device's sound-generation system.

FIGS. 6A through 6C illustrate examples of audio generated by sound-generation systems of different computer systems, according to examples.

FIG. 7A illustrates an example audio signal generated by the sound-generation system of a personal computing device.

FIG. 7B illustrates an example of an audio output and system which can be generated by a personal computing device as that device plays a source audio waveform containing square waves.

FIG. 8A illustrates an example 400 Hz sine wave at maximum (e.g., 100%) amplitude.

FIG. 8B illustrates an example 513 Hz sine wave at maximum (e.g., 100%) amplitude.

FIG. 8C illustrates an example waveform resulting from combination of a 400 Hz sine wave (at maximum amplitude) and a 513 Hz sine wave (at maximum amplitude).

FIG. 9A illustrates an example 400 Hz sine wave at maximum (e.g., 100%) amplitude.

FIG. 9B illustrates an example 513 Hz sine wave at half maximum (e.g., 50%) amplitude.

FIG. 9C illustrates example waveforms resulting from combination of a 400 Hz sine wave (at maximum amplitude) and a 513 Hz sine wave (at 50% of maximum amplitude).

FIG. 10A illustrates a frequency responsivity as between multiple speakers.

FIG. 10B illustrates an example frequency responsivity of a speaker (and the corresponding sound generation system) for an actual personal computing device.

FIG. 11 illustrates an approximate degree to which the built-in microphones (as opposed to the microphones in headsets) of different devices are sensitive to sounds of various frequencies.

FIG. 12A illustrates an audio waveform suitable for use when generating a discontinuous audio signature for a personal computing device.

FIG. 12B illustrates a recorded audio waveform of when a personal computing device records the sound generated by its simultaneous playing of a source audio waveform, such as illustrated in an example of FIG. 12A.

FIG. 13A illustrates additional examples of actual discontinuous audio signatures obtained from an example device.

FIG. 13B illustrates additional examples of actual discontinuous audio signatures obtained from another example device.

FIG. 13C illustrates additional examples of discontinuous audio signatures obtained from another example device, according to another example.

FIG. 14 illustrates an example method for automatically locating a pair of vertically-inverted signature waveforms such as illustrated in FIGS. 12B, 13A, 13B and 13C.

FIG. 15A illustrates an example method for utilizing a matrix signature representation for transforming a discontinuous audio waveform (e.g. of the type illustrated in FIGS. 12B, and 13A-C) into a format that is suitable for comparison with other similarly transformed discontinuous audio waveforms.

FIG. 15B illustrates the matrix signature representation of a set of discontinuous audio signature waveforms, according to another example.

FIG. 15C illustrates the matrix signature representation of a set of discontinuous audio signature waveforms, according to another example.

FIG. 15D illustrates the matrix signature representation of a set of discontinuous audio signature waveforms, according to an example.

FIG. 16 illustrates an example of an implementation with use of one or more embodiments.

### DETAILED DESCRIPTION

Examples include a system and method for determining a device-unique signature capable of accurately identifying a particular mobile phone, tablet, or other personal computing device. To generate such a signature, and establish or verify the signature-based identity of a personal computing device, a digital audio file, which specifies a digitized waveform, possessing one or more discontinuities, is created and played on the target computing device. Various unique (or identifying) attributes of the device's resulting recording of the sound that is emitted by the device in response to the device's playing of the discontinuous portion(s) of the audio file are used to formulate the signature of the target device. A variety of attributes, and/or any combination thereof, may be used to generate a device-specific signature. And many methods are available to facilitate the quantitative comparison of two device signatures.

Because the hardware, electronics and/or software of a personal computing device are unable to generate a sound that perfectly matches the discontinuous portions of a digital source audio file, the playing of such a discontinuous audio waveform by a personal computing device will result in the production of a sound not specified by the digital source audio. The general pattern of sound that will be associated with a device's playing of a discontinuous waveform will reflect the range of frequencies, and frequency-dependent amplitudes, which the device is capable of generating. However, this general pattern of sound will be modified as a result of the unique frequency-dependent responsivity of the device's speaker and microphone. The device's recording of a discontinuous audio waveform, that is played by the same device, will incorporate unique attributes and characteristics arising from the unique frequency-specific behaviors and relationships characteristic of, and intrinsic to, each particular device. Thus, the device's recording of its own playback of a discontinuous source audio generates an audio signature that no other device can precisely duplicate.

Such a device-specific recording of its own playback of a discontinuous audio waveform may thus be used to uniquely identify a particular mobile phone, tablet, or other computing device, and to differentiate one such device from others.

According to examples, a “computing device” includes a machine, real or virtual, that is capable of processing data. A computing device may be, at least partially, composed of, and inclusive of, a set of hardware components, electronic and/or electrical components, memory components, and other real, physical, tangible, items composed of atoms and having mass. A computing device may also be, at least partially, composed of, and inclusive of, a set of software components, virtual components, repositories of binary data- static and/or dynamic, algorithms, subroutines, and other fungible, intangible, virtual components whose character is dependent upon the context within which it is interpreted and/or executed.

A “continuous signal or waveform” can include an audio profile or shape that does not contain any discontinuities, meaning at all points it has a limit and a finite derivative. A continuous signal is a “smooth” signal, where the signal is defined over a certain range. For example, a sine function is a continuous signal, as is an exponential function or a constant function. A portion of a sine signal over a range of time 0 to 6 seconds is also continuous. Examples of functions that are not continuous would be any discrete signal, where the value of the signal is only defined at certain intervals.

Examples described herein include a system and method for creation, analysis and use of a digitized audio file recorded by a personal computing device, wherein the recording is of a sound generated in response to the playing of a source digitized audio file containing a discontinuous waveform. Such a recorded audio file, and/or a summary of its attributes and/or characteristics, will be referred to as a discontinuous audio signature. A source discontinuous audio need not be regular or repeating.

A “discontinuous signal or waveform” includes an audio profile or shape, i.e. a pattern of sound, that contains one or more “discontinuities.” A discontinuity in an audio waveform is an abrupt change in amplitude or slope; one that cannot be accurately recreated without the contributions of an infinite number of harmonic frequencies of ever-increasing frequencies. Or, from a more practical perspective, a discontinuous waveform is a sound, especially the digital specification of a sound, that cannot be recreated in a practical manner with complete and perfect accuracy since such a perfect recreation of the sound would require the production of an infinite number of harmonics of increasingly low volume but of increasingly high, and eventually beyond impossibly high, frequencies. Examples of discontinuous waveforms include, but are not limited to: square waves, and sawtooth waves.

Discontinuities are an artifact of some signals that make them difficult to manipulate for a variety of reasons. In a graphical sense, a periodic signal has discontinuities whenever there is a vertical line connecting two adjacent values of the signal. In a more mathematical sense, a periodic signal has discontinuities anywhere that the function has an undefined (or an infinite) derivative. These are also places where the function does not have a limit, because the values of the limit from both directions are not equal.

A “hard discontinuity” includes a point in a waveform in which the value instantaneously changes from one value to another in a manner that leaves a significant gap between the adjacent values. Such a discontinuity is graphically represented by a vertical line.

A “soft discontinuity” includes point in a waveform in which a value represents a “pivot” or inflection point that separates two adjacent regions wherein the slope of the point differs with respect to which of the two neighboring regions from which it is calculated.

“Distortion” includes a change in the wave-shape of a signal from the input of a device to the output. For example, distortion includes a change in tone

Within this disclosure, the term “microphone” should be regarded as denoting, and being inclusive of, a sound-recording system, module, and/or component of a computing device, unless otherwise noted. A computing device's sound-recording system is intended to include electronics, software, machine code, structural elements, magnets, coils of wiring, flexible membranes, and any and all other components, elements, pieces, sub-systems, etc., required for and/or involved in the recording of sounds by said computing device.

A “periodic function” in mathematics is a function that repeats its values in regular intervals or periods. Periodic functions include trigonometric functions, which repeat over intervals of 2n radians. Periodic functions are used throughout science to describe oscillations, waves, and other phenomena that exhibit periodicity. A function which is not periodic is called aperiodic.

A “piecewise linear function” in mathematics is a function composed of straight-line sections. An example a piecewise linear function is a piecewise-defined function whose pieces are affine functions. If the function is continuous, the graph of such a function will be a polygonal curve.

A “personal computing device” includes computing device which is capable of generating sounds, presumably, although not exclusively, for the purpose of facilitating the interaction of its programs with human users and/or operators. Typically, if not most commonly, referring to mobile phones, smart phones, tablet computers, laptop computers, desktop computers, gaming systems, etc.

A “ringing” includes oscillating wave that diminishes with time, usually diminishing at an exponential rate. A ringing pattern tends to occur during the attempted playing of a digital audio waveform that contains a discontinuity. Since the accurate creation of the discontinuity would require the generation of an infinite series of harmonic frequencies, and since real-world sound-generation systems are incapable of generating infinite series of harmonic frequencies, any real-world attempt to “play” such a discontinuous audio waveform will result in the creation of a ringing pattern.

A “sawtooth wave” (or “saw wave”) is an example of a non-sinusoidal waveform. In an example, such a wave may resemble the teeth of a saw. In an example, a sawtooth wave ramps upward and then sharply drops. However, in a “reverse (or inverse) sawtooth wave”, the wave ramps downward and then sharply rises. This can also be considered an example of an asymmetric triangle wave. In an example of the use of a sawtooth wave, a sawtooth wave may be used which has a “ramp” and “cliff.” On the sawtooth wave's “ramp”, the magnetic field produced by a deflection yoke may drag an electron beam across the face of a CRT, creating a scan line. On the wave's “cliff”, the magnetic field suddenly collapses, causing the electron beam to return to its resting position as quickly as possible.

A “signature” includes, among other aspects and examples, an attribute, set of attributes, pattern of attributes, quantifiable characteristic, set of characteristics, pattern of characteristics, or any other measureable value, that can be derived from a device, from a part, element, module, component, or portion of a device, or, from any combination of parts, elements, modules, components, or portions of a device, and that may be used to identify that device, and to distinguish or differentiate that device from other devices.

Within this disclosure, the term “speaker” includes a sound-generation system, module, and/or component of a computing device, unless otherwise noted. A computing device's sound-generation system is intended to include electronics, software, machine code, structural elements, magnets, coils of wiring, flexible membranes, and any and all other components, elements, pieces, sub-systems, etc., required for and/or involved in the generation of sounds by said computing device.

A “target computing device” includes a particular personal computing device for which the creation of a signature is desired.

A “user” refers to a human operator of a personal computing device.

A “waveform” is the shape and form of a signal such as a wave moving in a physical medium or an abstract representation. With respect to waveforms, the Fourier series describes the decomposition of periodic waveforms, such that any periodic waveform can be formed by the sum of a (possibly infinite) set of fundamental and harmonic components. Finite-energy non-periodic waveforms can be analyzed into sinusoids by the Fourier transform.

A “periodic waveform” includes waveforms formed by the following equations (with t being time) for sine waves, square waves, triangle waves, and sawtooth waves; other waveforms may be called composite waveforms and can often be described as a combination of a number of sinusoidal waves or other basis functions added together:

Sine wave: sin (2πt). The amplitude of such a waveform follows a trigonometric sine function with respect to time.

Square wave: saw(t)−saw(t−duty). Such a waveform may be used to represent digital information. A square wave of constant period contains odd harmonics that fall off at −6 dB/octave.

Triangle wave: (t−2 floor((t+1)/2))(−1)floor((t+1)/2). Such a waveform may contain harmonics that fall off at −12 dB/octave.

Sawtooth wave: 2(t−floor(t))−1. Such a waveform may be used in time bases for display scanning. Furthermore, such a waveform may be used as the starting point for subtractive synthesis, as the sawtooth wave of constant period contains odd and even harmonics that fall off at −6 dB/octave.

Some examples described herein exploit a unique nature of every macroscopic physical object. It is statistically unlikely that any two macroscopic objects will have the same numbers of atoms, the same numbers of each type of atom, precisely the same macroscopic shape (at the atomic scale), etc. One consequence of each object having a unique composition, and unique dimensions, is that the behaviors of those objects will likewise display unique and differing properties, characteristics, behaviors, etc. For example, every macroscopic physical object has a unique resistance, capacitance, strength, fundamental frequencies, elasticity, etc. The sensitivity and precision required to measure some of these differences may be extreme, but the differences are real. And, very small differences between individual objects can be greatly magnified when those differences are compounded, e.g. within an electrical circuit.

Speakers are physical objects which may be fabricated with components such as magnets, coils of wire, and diaphragms. Magnets can vary in their strength, in their size, in their mass, etc. Coils of wire can vary in the diameter of the wire at any or all points along the length of the wire. Furthermore they can vary in the number of loops of wire, or the precise composition of the metal alloy (even when purported made of a “pure” metal). Diaphragms can vary in the thickness of the film, fabric, sheet, etc., from which they are made. They can vary in the composition of the material from which they are made. They can contain unique imperfections, tears, creases, bends, etc.

Microphones are also physical objects and may be fabricated from components such as magnets, coils of wire, and diaphragms.

Furthermore, some types of speakers and microphones operate in conjunction with physical objects that transform and control the flow of electrical currents. These physical objects might include resistors, capacitors, induction coils, wires, batteries, transistors, etc. Resistors can vary in the precise values of their resistance. Capacitors can vary in the precise values of their capacitance. Batteries can vary in the precise values of their voltages.

Physical objects from which personal computing devices are fabricated, and through which electrical currents flow, are unique. Thus, each physical object within a personal computing device adds to the uniqueness of that device's behavior. And, the great numbers of unique individual components within a personal computing device, when operating together to create, shape and regulate electrical signals, and to generate macroscopic behaviors discernable to humans, can create very noticeable, and easily quantifiable, differences in the attributes of those macroscopic signals and behaviors.

The uniqueness of the behavior of a personal computing device extends to both the sound generation, and to the sound-recording, components of that device.

The use of a source audio waveform possessing specific characteristics and attributes can amplify the magnitude and number of device-unique differences between the source and recorded versions of the audio waveform. Through the use of a source audio waveform possessing such specific characteristics and attributes, the effort, resolution and accuracy associated with the identification of a specific personal computing device through the examination and/or analysis of a device-specific recording of a device-specific playback of such a source audio waveform can be greatly simplified and improved. By using a source audio waveform possessing specific characteristics and attributes, an identification methodology can be implemented.

When a personal computing device attempts to play a source audio waveform that contains attributes and/or characteristics that are not reproducible, the actual sound that is generated may deviate from the sound specified in the source audio. More importantly, such a deviation may include artifacts that arise from the overstimulation of the hardware and/or electronics of the device's sound system. These artifacts will be unique consequences of the unique attributes of those hardware and/or electronics.

For example, a frame that holds a speaker will likely have unique dimensions (if examined with sufficient resolution) and characteristics (e.g., fundamental frequency; assortment of structural and compositional imperfections which affect the vibrations that arise from it). The interaction between a speaker and the frame by which it is attached to a personal computing device will be unique with respect to the vibrations (e.g., frequencies and amplitudes) generated by the other components of the sound system.

The digital specification of any particular audio waveform is typically virtual, constant, fungible, and invariant. However, the sound manifested by any particular personal computing device as a result of its “playing” of such an audio waveform will reflect the combination and compounding of the unique attributes of each individual electrical, magnetic and/or structural component involved in the execution and/or manifestation of its playing. Therefore, even though a source audio waveform may be virtual, constant, fungible, and invariant, the sound that results from its playback will be a unique reflection of the collection of unique components that create it. And, such a device-specific playing of a constant and invariant audio waveform will be unique, and can, with sufficiently sensitive recording and analysis tools, be used to uniquely identify the device that gave rise to it.

The same type of device-unique sound processing as exists in the sound-generation system of a device also exists in its sound-recording system (if it has one)! Even if it were possible to present to a personal computing device's sound-recording system a constant and invariant set, pattern, or progression of sounds, the audio file created during the recording process by that device will be unique, and will contain unique attributes, and could, with a recording of sufficient resolution and precision (bits-per-sample and samples-per-second), be used to uniquely identify the device.

When combined, so as to impart their device-unique attributes on to a regenerated device-unique recording of a source audio waveform, the device-unique sound-generation attributes and characteristics, as well as the device-unique sound-recording attributes and characteristics, intrinsic to a personal computing device allow such a recording of a known source audio waveform to be used to uniquely identify that particular personal computing device and to differentiate it from other such devices.

The personal-computing-device identification system herein utilizes a source audio waveform that contains one or more discontinuities. When the device plays the source audio, the sound that is generated contains “ringing” at or near the point(s) of the discontinuity(s). This ringing is caused by the inability of the device to perfectly generate the discontinuity(s) specified in the source audio file.

At the same time that the discontinuous source audio waveform is played on a personal computing device, the device's microphone records the sound generated.

The resulting digitized recording of the playback of the discontinuous audio waveform is then available for immediate analysis on the personal computing device, or, as is preferred, the recorded sound file is returned to a server where its similarity to prior recordings from the same device, and/or to the device whose identity has been suggested to the server through one or more credentials submitted to the server, perhaps fraudulently by a hacker's device.

The current device signature can be quantitatively compared to past signatures associated with the same device ID by means of a number of different algorithms, some of which are discussed elsewhere in this disclosure.

In implementations, a reaction of a personal computing device's sound system to the attempted playback of a non-reproducible audio waveform is the emission of a “ringing” sound. The “ringing” sound can occur when the waveform to be played contains a plateau, such as when that plateau is at a maximal or minimal voltage. The spectrum of frequencies, the phase relationships of those frequencies, their relative amplitudes, etc., can combine to create a unique pattern of ringing in response to the attempted playback of a non-reproducible audio waveform.

Some computing devices may not reproduce certain types of source audio waveforms. An example of such a waveform is a waveform which involves the specification of an abrupt change in the voltage followed by the continuation of that specified voltage for at least a short period of time. The components of most device speakers impart inertia to the part(s) of the speaker that vibrate in order to create sound. Thus, when the moveable component(s) of a speaker are abruptly driven to a maximal position, the own inertia makes it impossible for those moveable components to suddenly stop and hold their relative position. Instead, the moveable components oscillate while their inertia-driven movements are damped by the elastic and/or springy component(s) of the speaker. Thus, the sound that results from the attempt to play an audio waveform that specifies an abrupt jump to a voltage that is thereafter held constant may include a ringing oscillatory sound that diminishes exponentially with time.

The discontinuous source audio that is played on a personal computing device can be placed on, or made accessible to, the device in a number of different ways, each of which has advantages and disadvantages.

If an application installed on a personal computing device downloads a copy of the source audio file prior to each generation of a discontinuous audio signature then it may be possible to modify that source audio file at any time without installing that file onto any computing devices before the signature generation process among all computing devices is modified. This facilitates the distribution and use of up-to-date source audio files.

Another potential benefit of having personal computing devices download one or more source audio files that will be used as the basis for the generation of a discontinuous audio signature prior to each generation cycle, or, at least prior to a set of generation cycles, is that a server can send customized, unique and/or randomly-generated source audio files to each particular personal computing device. This protocol would have the benefit of allowing servers to confirm that a discontinuous audio signature file submitted to the server by a personal computing device is legitimate since it will have been generated with a source audio file that presumably could not have been anticipated, nor duplicated in real time, by a hacker. In other words, this protocol would provide a server with some assurance that the discontinuous audio signature file submitted by a personal computing device was generated only moments earlier (i.e. no earlier than the time at which the unique discontinuous source audio file was downloaded and/or created by the server) and was not, by contrast, pre-generated by a hacker and submitted as part of an attempt to fool the server into thinking that the source personal computing device is a different device.

Another potential benefit of having personal computing devices download some source audio file(s) that will be used as the basis for the generation of a discontinuous audio signature prior to each generation cycle, or, at least prior to a set of generation cycles, is that a server can incorporate non-discontinuous audio elements, e.g. a duck quacking, etc., that allow the validity and real-time origin of a discontinuous audio signature file to be verified at the time of its upload.

Suitable discontinuous source audio files can be generated programmatically by an application, or other software, resident upon a personal computing device. The qualities, characteristics, attributes, and/or other audio components, can be added to the source audio by the application. Those elements can be statically defined and/or chosen, perhaps in a manner or selection that is unique to a particular computing device. Those elements can be randomly selected each time the source audio is generated. Or, those elements specified by a server at the time, and/or each time, it requests of the personal computing device the generation of a discontinuous audio signature.

The on-device generation of a discontinuous audio file on a personal computing device prior to the generation of a discontinuous audio signature can help to save static memory on the computing device, generating the audio file only when it is needed, and only requiring its storage in volatile memory (where it would needed in any event in order to be played back) rather than in both volatile and static memory.

The on-device generation of a discontinuous audio file on a personal computing device prior to the generation of a discontinuous audio signature can help to reduce the amount of data that must be exchanged between a personal computing device and a server during the process of initiating and returning a discontinuous audio signature file. If the source audio file is downloaded from a server to a computing device each time a signature file, or set of signature files, is to be generated, then the transmission of that source audio file to the computing device will require the use of some of the available network bandwidth. The on-device generation of such source audio waveform(s) and/or file(s) eliminates the need to utilize a perhaps significant portion of the available network bandwidth.

Another potential benefit of generating a source discontinuous audio file on a personal computing device, rather than transmitting it from a server to a device prior to the generation of a discontinuous audio signature, is that a particular type of personal computing device may require a particular format, particular sample rate, etc., for the source audio that is to be played as a part of the signature generation process. By relegating the responsibility for the generation of the source audio to an on-device application, the peculiarities required in the format of that audio file can be handled by an application that is already configured for the computing platform upon which it operates. Potential alternatives to this include downloading a possibly-customized source audio file from a server in the format required by the personal computing device each time the source audio is required, as well as loading a properly-formatted source audio file at the time that the application is installed. However, both of these options have disadvantages. For instance, dynamically downloading custom-formatted source audio files adds to the complexity of the server(s), the signature-generation process and of the maintenance of the software and source data. And, installing a static source audio file on a personal computing device removes the potentially beneficial possibility of dynamic customizations to the source audio, where such customizations could potentially help thwart attempts at hacking.

It would be possible to simply store a source discontinuous audio file on a personal computing device, perhaps at the same time that an application, or other software, that will ultimately execute the signature-generation process. However, while this approach may reduce network traffic (by precluding the need for transmissions of source audio files from a server to a computing device prior to signature-generation cycles), this approach is less robust to hacking in that dynamically customized source audio files are not as easily created or accessed. An audio file may be installed, or modified after installation, that specifies a device-specific customized source audio waveform. Thus, every signature generated on any particular personal computing device will be based upon a unique source audio file. This increases the difficulty of making an accurate and/or credible simulation of a signature file.

The task of evaluating and comparing signature audio files may be simplified and/or helped if the options that customize the kind and/or character of the sounds created by a personal computing device are turned off, set to their default values, and/or, set to known and reproducible sets of values. Likewise such a task may be further simplified and/or helped if any optional sound-recording settings are turned off, set to their default values, and/or set to specific and reproducible values.

For example, on an iPhone running iOS™ version 6.0 it is helpful to put the phone into “measurementMode” and to set the gain on the microphone to its maximum value. To put an iPhone™ into “measurementMode” one invokes the AV Audio Session library, and sets the “mode” to the “AVAudioSessionModeMeasurement” option. This measurement mode is specified when the app is performing measurement of audio input or output. When this mode is in use, the device does minimal signal processing on input and output audio.

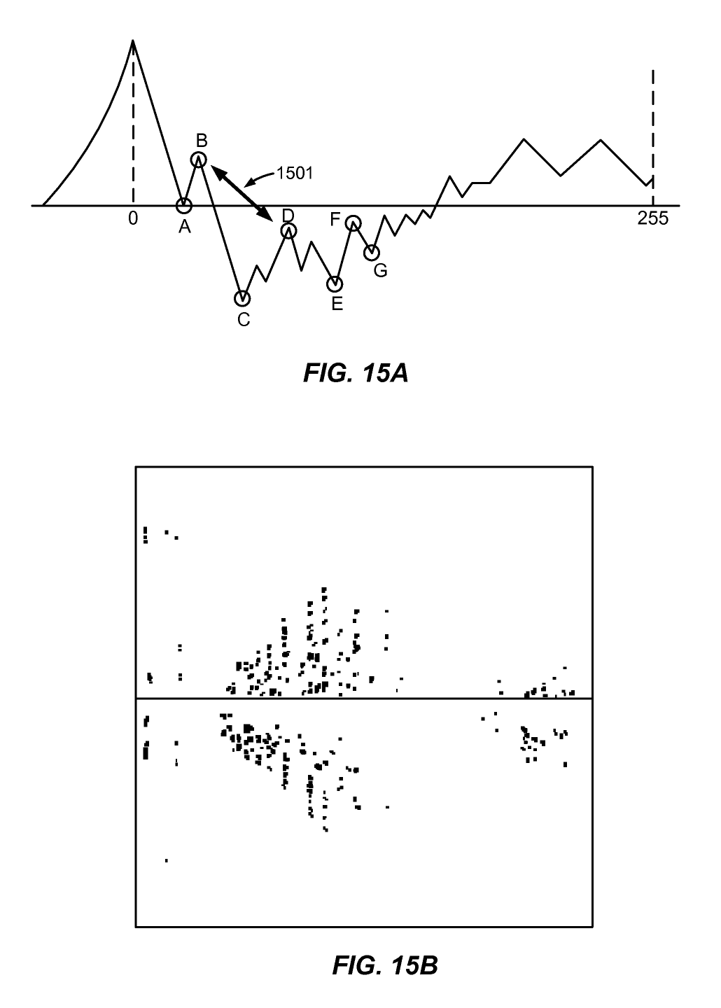

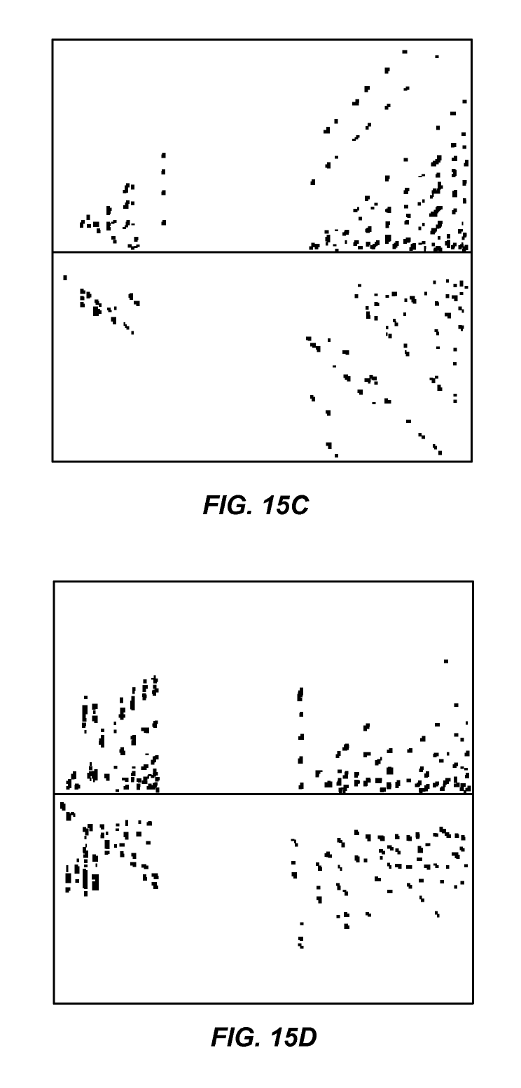

An example of a method for comparing a pair of discontinuous audio signatures to determine whether or not they were generated by the same personal computing device or different personal computing devices is discussed below in relation to FIGS. 15A-D.

Another example of such a method would be to keep a running total of the “sum of amplitudes”, “sum of the squares of amplitudes”, and “number of amplitudes” with respect to each x axis position along the lengths of the audio signatures within a set of audio signatures. The “amplitudes” would be the absolute amplitudes of each signature with respect to each x axis coordinate. This would allow the comparison of two arrays of such values by determining the number of standard deviations required for the distribution of amplitudes associated with each x-axis position to overlap. By weighting the number of standard deviations required for overlap per x-axis coordinate with the average absolute amplitude at that x-axis coordinate, a weighted average number of standard deviations of separation can be calculated. The separation of two (sets of) audio signatures in terms of their weighted number of standard deviations of distance can be converted to an equivalent probability of sharing a common origin by determining the area under a standard Gaussian distribution that would be included within the mean of the distribution plus and minus that number of standard deviations.

A further method would be to determine the area between the (average) audio signature curves. The smaller the area, the more likely two (sets of) audio signatures originated from the same personal computing device.

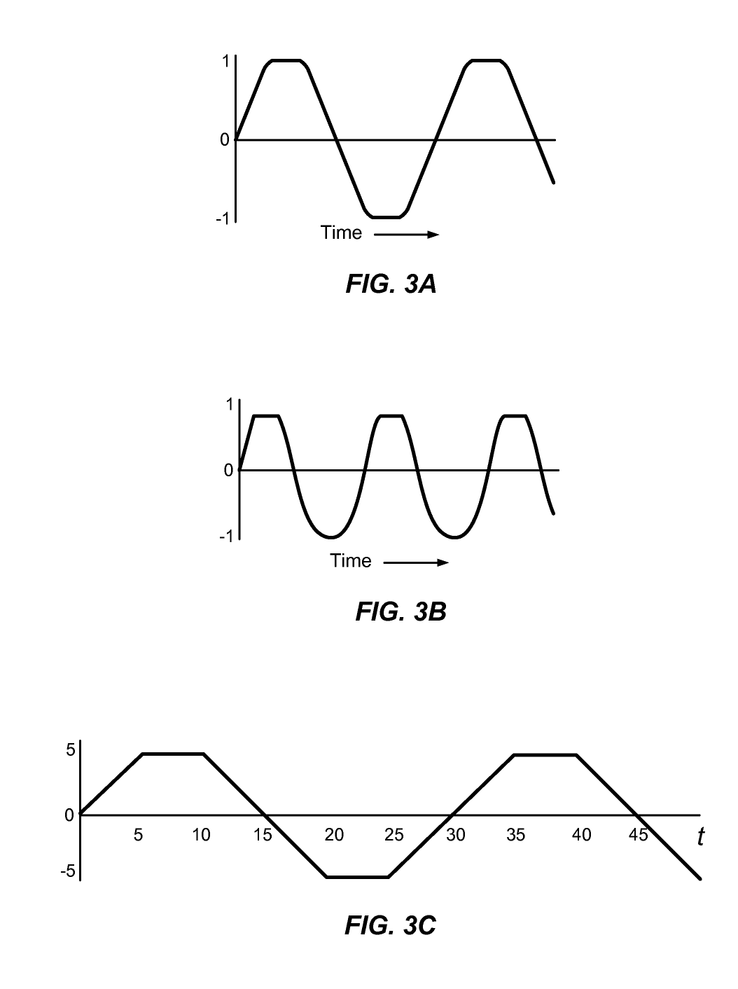

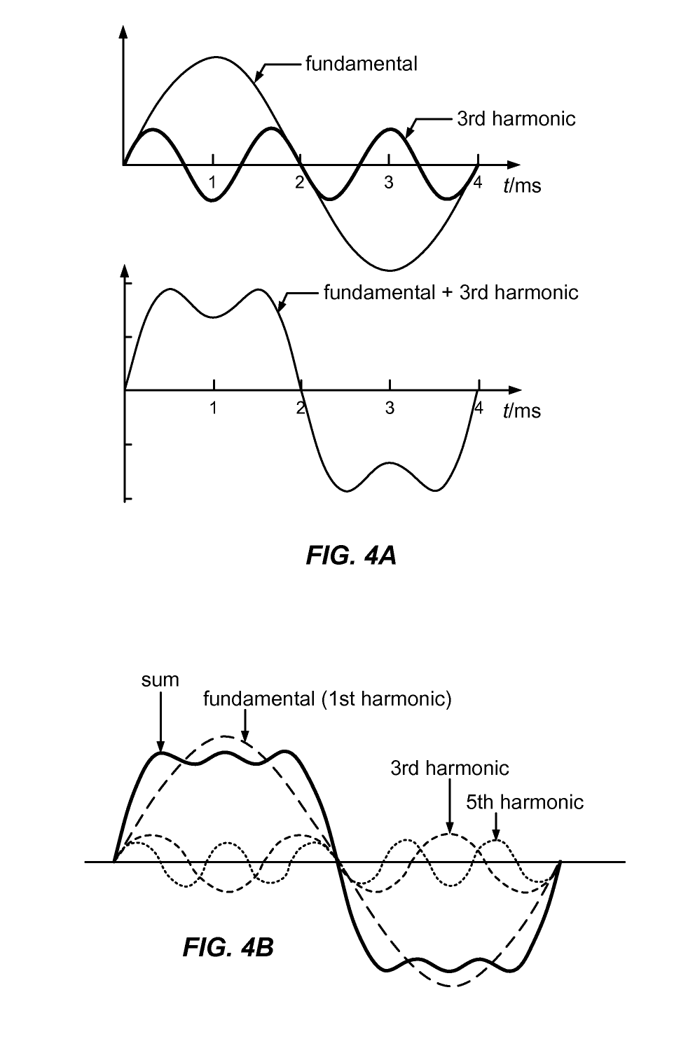

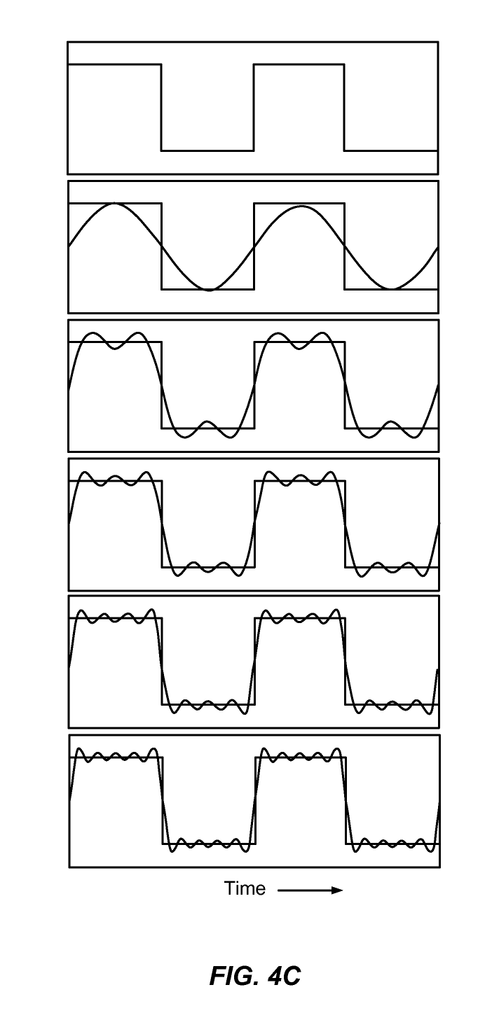

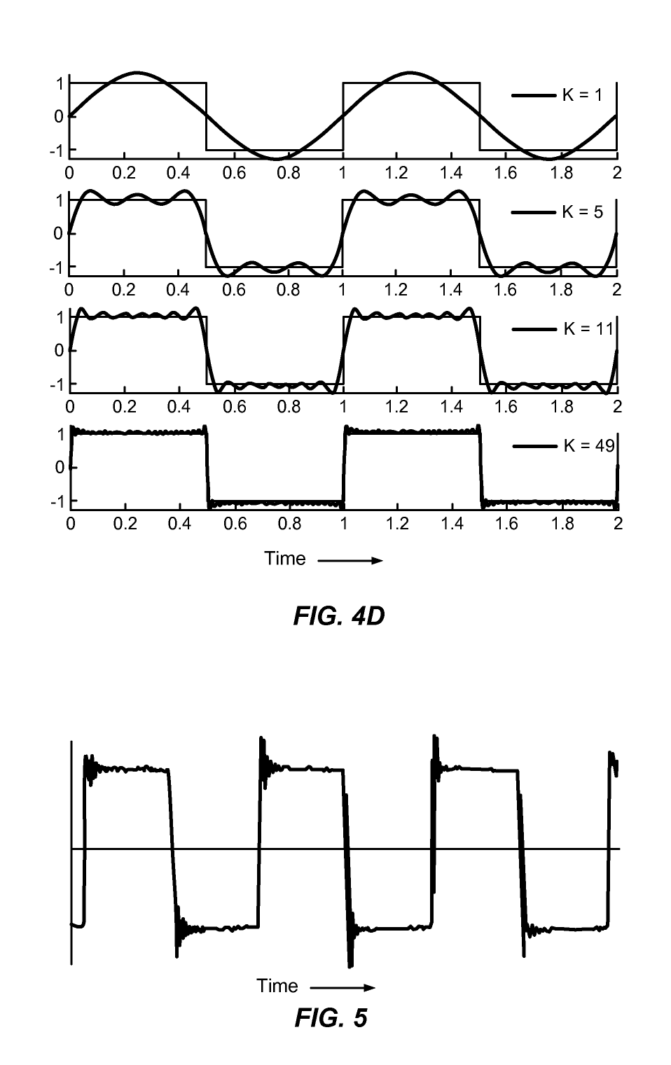

Using the playback and recording of discontinuous audio waveforms as the basis for the generation of a device-specific and device-unique signature provides advantages over the use of non-discontinuous waveforms. One example of a discontinuous audio waveform for use as the basis for the generation of an audio signature of the kind provided for herein is that of a single square wave (see FIGS. 3A and 4A). While the source audio waveform is that of a square wave, the electronics, and the limited frequency range of a personal computing device, will result in the generation of a square wave with ringing (see FIGS. 4B and 4C). The amount, amplitude, frequency and duration of ringing will depend upon the unique attributes of the components of the personal computing device. Furthermore, because the range of frequencies to which a device's microphone will be sensitive is limited, the sound recorded will be limited to the range of frequencies within the ringing which is within the range of frequencies to which the device's microphone is sensitive (see FIG. 4D).

In general, the ringing sound generated by a personal computing device during its playback of a square wave sounds like a “click.” With respect to digital devices, electronic devices, user interfaces, etc., the “click” sound is ubiquitous. Such a sound is less likely to command the attention, or disrupt, a user.

By using a “click” sound as the basis for the generation of a discontinuous audio signature, signatures can be generated by a personal computing device without the user of that personal computing device being aware their generation.

One possible embodiment would involve having a personal computing device play a discontinuous audio waveform, and simultaneously record the sound emitted by the device, in response to each press and/or release of a button on one or more of the user interfaces on the device. For example, each time the user of a personal computing device presses a key on, for instance, a virtual keyboard displayed on the screen of a tablet computer, the computer could play a discontinuous audio waveform, record the ensuing “click” sound, and send the digitized recording of the click back to a server (or perhaps archive that recorded audio file on the device for later analysis and/or transmission to a server).

Since many key presses on virtual keyboards and buttons are already associated with the emission of a “click” sound, in order to provide a user with an indication and acknowledgement that a button has been pressed, the substitution of a static “click” audio waveform for that of a discontinuous waveform will likely not be noticed by a user. Thus, the generation of not only one, but of many instances of a discontinuous audio signature can be performed without the knowledge or disruption of the human user of a personal computing device.

As mentioned above, the generation of a unique identifying signature of a personal computing device through the generation and recording of a single “click” sound enables the generation, collection and analyzing of many discontinuous audio signatures from a personal computing device. By generating, analyzing, validating and verifying the device-specific attributes of discontinuous audio signatures for a personal computing device regularly and frequently during a human's use of that device helps to ensure that the instructions, controls, data and other credentials obtained from that device during the course of any particular transaction are legitimate and originate from the actual authorized agent and/or holder of the account, rather than from a hacker who otherwise might be able to take control of a server session, and use it to steal monies from an account, after the authorized user has submitted his credentials.

The range of frequencies that the sound-generation system of a personal computing device can generate, as well as the maximum relative amplitude of each frequency within that spectrum, will vary, at least to some degree, between different personal computing devices. The ringing that arises from every attempt of a personal computing device to generate a discontinuous audio waveform will likely be affected by the limiting minimum possible frequency that a computing device can generate, as well as the limiting maximum possible frequency that it can generate.

The ringing pattern associated with a personal computing device's generation of a discontinuous audio waveform incorporates a broad range of frequencies. When some of those frequencies cannot be manifested by the device, the ringing pattern is altered. It is therefore useful to have a personal computing device attempt to generate an output sound whose accurate reproduction would require a broad spectrum of frequencies so that the chances that the spectrum of frequencies required to accurately reproduce the discontinuous waveform will exceed at least one end, but preferably both ends, of the range of frequencies which the device is capable of —generating—so as to manifest a ring pattern that deviates from ideal in a device-specific manner.

It is possible to identify and differentiate personal computing devices through the playing, recording and analysis of audio waveforms and sounds that are not associated with the discontinuities. For example, continuous audio waveforms, comprised of one or more frequencies each, can be played and recorded in order to generate recorded audio files wherein the waveforms will reflect the unique attributes and behaviors of each personal computing device. However, disadvantages for this type of signature generation and analysis include: 1) the user of the device would have to hear these tones as they were played and recorded (which might meet with some frustration and resistance by users); and 2) the number of frequencies for which device-unique attributes and behaviors would be represented and sampled would be relatively small. Major differences between devices might not be revealed making the identification and differentiation of devices dependent upon a few, possibly minor frequency-dependent differences.

Instead of generating a “ringing” audio waveform by attempting to playback a source audio waveform containing a discontinuity, it would be possible to simply use as a source audio a continuous ring waveform. This may have a disadvantage of limiting the ring waveform a priori to a specific set of frequencies and frequency-specific amplitudes, whereas the ringing pattern that arises spontaneously during the attempted playback of a discontinuous audio waveform is not so limited.

Discontinuous audio (e.g. square waves, sawtooth waves, clipped waves) requires infinite number of harmonics (e.g. the fundamental frequency and odd harmonics at a level of 1/h). However, the actual shape of ringing sound artifact is not only the contribution of each frequency. Each frequency's contribution is non-linearly scaled such that the aggregate waveform is a unique reflection of the responsivity of the sound-generation system with respect to each frequency in the set of harmonic frequencies contributing to the discontinuous audio, and to the responsivity of the sound-recording system with respect to each frequency in the same set of harmonic frequencies.

Through the generation of a brief ring associated with the generation of a discontinuous audio waveform, the unique non-linearities of both the sound-generation and sound-recording systems of a personal computing device can be sampled and used to define a unique hardware-specific signature for the device.

Unique frequency-specific amplitudes lead to unique combined waveforms (and ringing) speakers have unique frequency responsivities. Furthermore microphones have unique frequency sensitivities.

Inverted “ring” patterns may be used in the automated location of patterns within noisy recordings. For example, these patterns may be used to more easily automatically locate patterns.

Examples herein provide for devices and systems which utilize sounds that are described in various manners (e.g., “smooth”; “buzzy”). In general “smooth” sounds are related to smooth waveforms, whereas “buzzy” or “harsh” sounds are related to sharp corners on waveforms.

According to examples, devices are provided for which create a harmonic distortions, which make musically pleasant sounding notes, and which minimize intermodulation distortion, which make un-musical “squarks” and buzzes. Embodiments recognize that the compression-limiting clipping that creates “tube-ish” distortion is very different in the information sense; while top of the wave may be compressed, the original information about what the input wave used to be is not lost, just compressed. Embodiments further recognize that distortion with this compression keeps some of the flavor of the original input and has uses for, by way of illustration, guitar players like.

In examples, “overdrive effects” are associated with “soft clipping,” where gain is reduced beyond the clipping point. In contrast, distortion may be associated with “hard clipping,” where the level is fixed beyond the clipping point. Distortion is associated with a “harder” sound (e.g., as used in rock music), while overdrive gives a more “natural” sound.

Examples herein provide for systems and devices which may utilize sound waves that have been asymmetrical clipped. For example, a side of a sound wave may be clipped more than another side.

In another example of clipping, clipping may occur when a sound exceeds a certain decibel level that hardware (e.g. microphone; sound recorder) can handle. Embodiments recognize that clipped sound may be associated with a muffled scratchy sound that listeners may find unpleasant.

In an embodiment, a device receives an input of a single frequency (pure sine wave), but the output waveform is clipped by an amplifier. Harmonic frequencies not present in the original signal are then produced at the output, which produces harmonic distortion. For example, the harmonic distortion may contain only odd harmonics if the clipping is symmetrical. In another example, a geometrical square wave may have only odd harmonics, and as a signal is clipped, it approaches a square wave rather than a sine wave.

In embodiments, devices may create or attempt to create a sound which at some portion of the sound's waveform would involve the stopping of the motion of the speaker; however, in implementations a damped oscillation of the speaker, which does not match the voltage profile of the driving audio signal, may occur. For example, with respect to a speaker device, the magnet and cone of the speaker may have inertia after put into motion, and the force required to stop such them (e.g., to stop the moving magnet) with an extremely deceleration may exceed the force that can be generated by the coil driving the magnet. This may cause ringing as the magnet overshoots and then over compensates cyclically until it comes to rest at the deflection specified in the audio waveform. In implementations, the playing of an audio waveform that accelerates and then decelerates the sound-producing portion of a speaker may do so to such a degree that the speaker exhibits a ringing output that deviates from the sound specified in the waveform, and, the recording of the speaker's ringing output with a microphone. Such a recorded pattern of ringing may form a signature unique to the speaker which generated the sound, and to the microphone that recorded it.

In embodiments, sound is created using equations which express some functions of time. In such embodiments, sound may be created without use of other data.

Embodiments herein provide for playback devices such as speakers which utilize sound waves. When a wave is sent to a speaker, the speaker will vibrate according to the shape of the wave.

Among other advantages of the present system, the present system may provide record/playback of sound using less costly components than other systems. For example, the present system may be implemented as a computer, microphone and clock radio to recognize and store sound (e.g., music, words, or inflections).

Embodiments herein provide for systems and devices which may utilize sounds produced via a process of sound synthesis. Such a process may include creating and playing back a sound wave on a computer or synthesizer. Synthesizers are machines or computer programs that create sound waves from data. Synthesizers may include physical features (e.g., knobs) which receive input to create sound waves (e.g., twisting a sound wave into a different sound wave). Synthesizes may produce sounds which are not found in nature. However, embodiments recognize that synthesizers may have difficulty synthesizing some sounds of traditional musical instruments (e.g., a violin), due to the complexity of the instrument and the musician.

Examples herein provide for systems and devices which utilize subtractive synthesis. Subtractive synthesis is based on filtering harmonically rich waveforms and due to various factors (e.g., simplicity) forms the basis of early synthesizers such as the Moog synthesizer. Among other aspects, subtractive synthesizers utilize an acoustic model that assumes an instrument can be approximated by a simple signal generator (producing sawtooth waves, square waves, etc.) followed by a filter.

Examples herein provide for systems and devices which utilize various waves used in in modern electronic music. For examples, such devices utilize waves including square waves, sawtooth waves, triangle waves, and sine waves. Such waves may be illustrated by display of non-smooth periodic waveforms, whose spectral energy is concentrated in a (large) set of discrete spectral lines (square waves, sawtooth waves, triangle waves).

An ideal square wave alternates periodically and instantaneously between two levels. An ideal triangular wave alternates periodically between a linearly rising portion and a linearly decreasing portion. An ideal sawtooth wave is a periodic series of linear ramps.

Source audio files may specify the generation of output sounds that, when modified and/or amplified by components and/or controls of the sound-generation systems of personal computing devices, exceed the capabilities of those systems. In these cases, the sound-generation system can output ill-formed, incomplete, distorted versions of the specified waveforms.

Some devices may produce “clipped” sounds. Clipped sounds can result from an attempt to drive a sound system past its limits with a source file (often coupled with the effect of equalizer and volume settings), for which the accurate reproduction would require the generation of an output sound that would exceed the capabilities of the sound system with respect to frequency, volume, etc. “Clipped” sounds can also arise accidentally and/or deliberately in the specification of a source audio waveform. Sometimes a source audio waveform can be created programmatically, and when the computed value(s) associated with a waveform would exceed the minimum and/or maximum value(s) that can be specified in the waveform with respect to the audio format, and number of bits available, then such value(s) are truncated to the minimum or maximum value possible.

In an example of clipping, waveform distortion may occur when an amplifier is overdriven and attempts to deliver an output voltage or current beyond its maximum capability. In a further example, the signal exceeds the maximum dynamic range of an audio channel. In appearance of a recording, the sound wave may appear that the top and bottom of the sound wave were cut.

In a further example, “hard clipping” distortion may occur when recording at a volume level that is higher than the maximum value that hardware supports. The hardware cannot store this value and simply records the highest value available. In a recording of such a waveform, the peaks may appear to be flattened off. In an alternative example of clipping, distortion (“soft clipping”) may be introduced by analog hardware such as tube-based amplifiers. Clipping may result in soft clipping (e.g., compression) of a signal.

In implementations, devices will have a maximum limit for which a signal can pass through. When the level of signal exceeds that maximum, the waveform of such signals may show waves for which the tops are “clipped off” (flattened out).

Some types of source audio waveforms are not reproducible on some, if not all, personal computing devices. All such variants are included within the scope of this disclosure.

The unique effects that electrical components exert on the transmission of electrical currents can vary with various factors; for example they may vary with the temperature of the component, with the humidity of the air at the surface of the component, with the strength, orientation and changes in magnetic fields passing over and/or through the components, etc. While the cumulative pattern of effects that will render the sound generated by a personal computing device in response to its playback of a source audio waveform may be unique, these effects may further vary with other factors (e.g., environmental factors; the amount of charge remaining in the device's battery; the orientation of the device).

Sound vibrations can propagate within a device through the structural members of its frame. Because the characteristics of structural device members are as unique as electronic components, the sound generated in response to the playing of a source discontinuous audio waveform can be modified by such structural contributions and electronic effects.

Sound generation may deviate from the ideal with respect to frequency amplitudes. Amplitudes are not constant over all frequencies; for example, some amplitudes may be missing altogether. An equalizer offers opportunity to customize volume per band of frequencies to correct natural nonlinearity and/or to enhance spectrum to suit one's taste.

Embodiments herein provide for systems and devices which utilize sound waves including triangle waves. A triangle wave is a non-sinusoidal waveform named for its triangular shape. It is a periodic, piecewise linear, continuous real function. Like a square wave, the triangle wave contains only odd harmonics, due to its odd symmetry. However, the higher harmonics roll off much faster than in a square wave (proportional to the inverse square of the harmonic number as opposed to just the inverse).

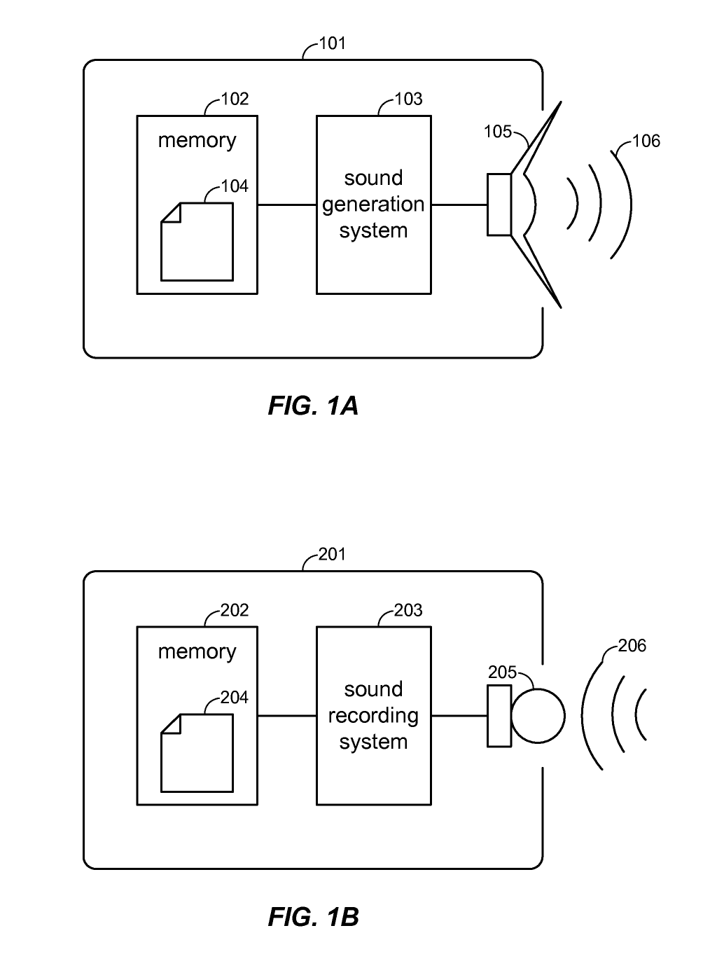

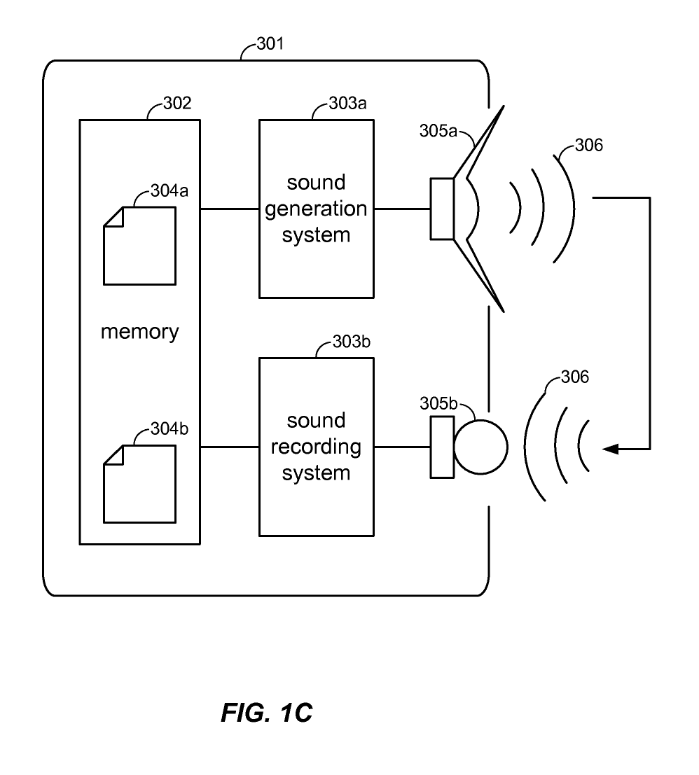

FIG. 1A is an illustration of a representative block diagram of a sound-generation system for a computing device, according to one or more examples. Among its other components, modules and systems is included a sound-generation system 103 which plays digital audio files 104 stored in digital memory 102. The sound-generation system 103 recreates sounds consistent with the digitized waveform(s) stored in the audio file 104 by controlling the electrical activation of a speaker 105 that emits sounds 106 as it vibrates in response to variations in the electrical signals, currents and/or voltages that control it.

FIG. 1B is an illustration of a representative block diagram of a sound-recording device, according to one or more examples. Sound-recording device 201 may be a device which is used to record the sound(s) generated by a personal computing device of the type illustrated in FIGS. 1A and 1C. Among its other components, modules and systems is included a sound-recording system 203 that digitizes and records in a file 204, stored in digital memory 202, the sounds 206 that impinge upon its sensor(s) 205 and stimulate its production of electrical signals, currents and/or voltages.

FIG. 1C is an illustration of a representative block diagram of a sound-generation and recording system for use with a computing device, according to one or more examples. Among the components of personal computing device 301, modules and systems is included a sound-generation system 303a which plays digital audio files 304a stored in digital memory 302. The sound-generation system 303a attempts to recreate sounds 306 consistent with the digitized waveform(s) stored in the audio file 304a by controlling the electrical activation of a speaker 305a that emits sounds 306 as it vibrates in response to variations in the electrical signals, currents and/or voltages that control it. Also among its other components, modules and systems is included a sound-recording system 303b that digitizes and records, in a file 304b stored in digital memory 302, the sounds 306 that impinge upon its sensor(s) 305b and stimulate its production of electrical signals, currents and/or voltages. The device-unique attributes and qualities imparted to the recorded waveform stored in digital audio file 304b, which arise from the device-unique sounds 306 generated by the sound generation system 303a, and speaker 305a, in response to the reference waveform specified in the source digital audio file 304a, can be used to identify personal computing device 301 and to differentiate it from other such devices.

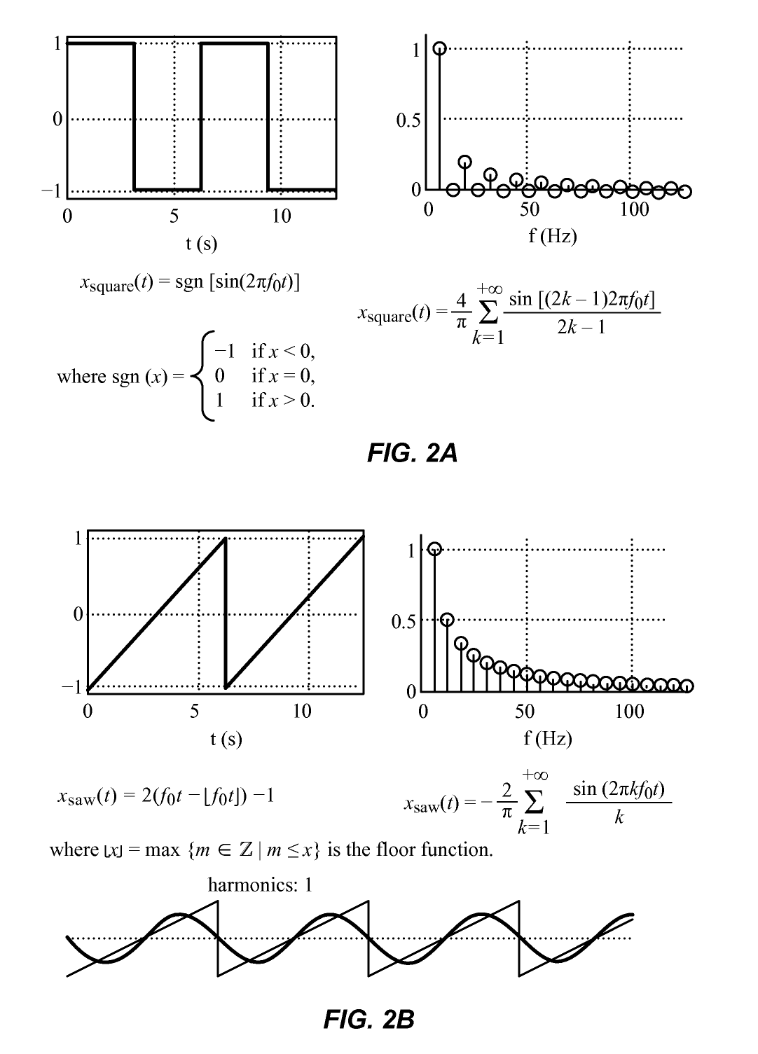

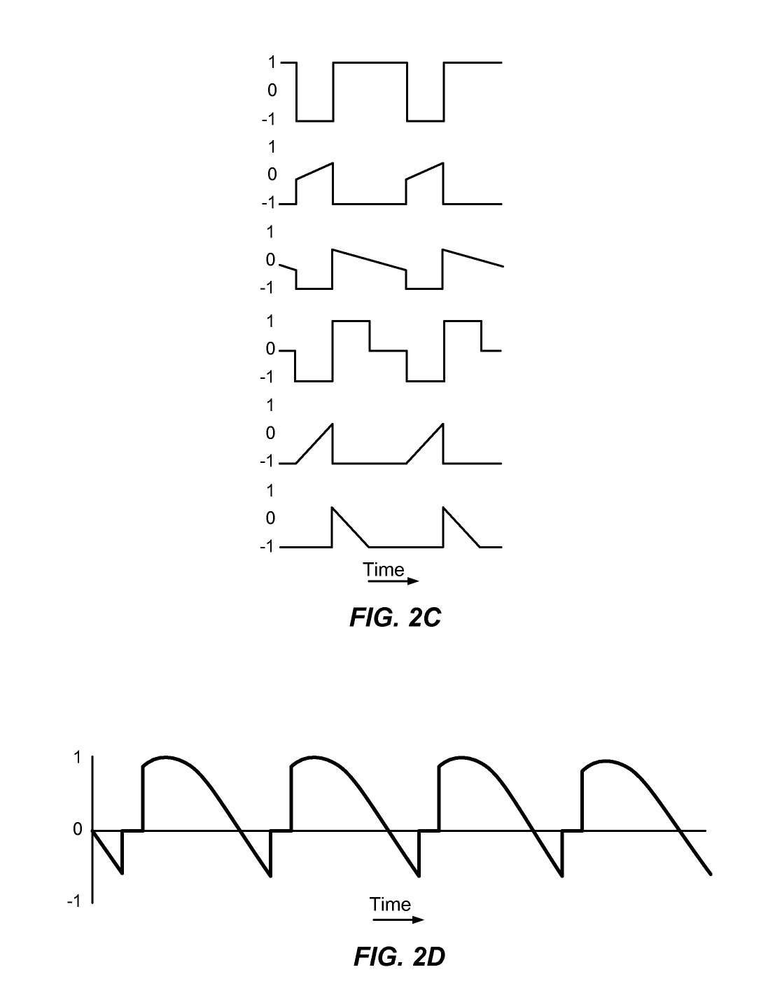

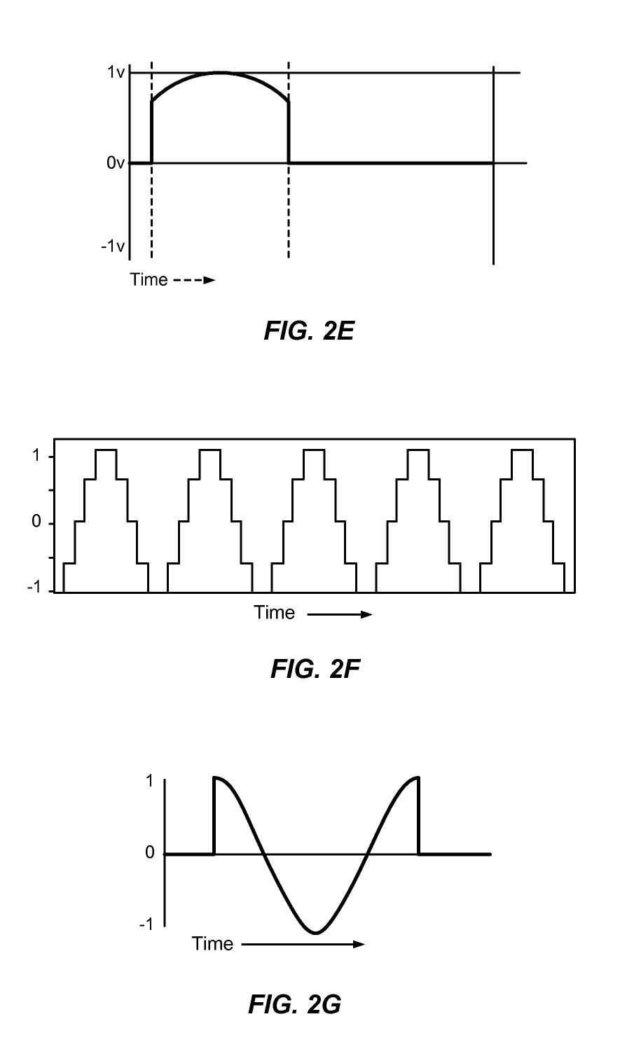

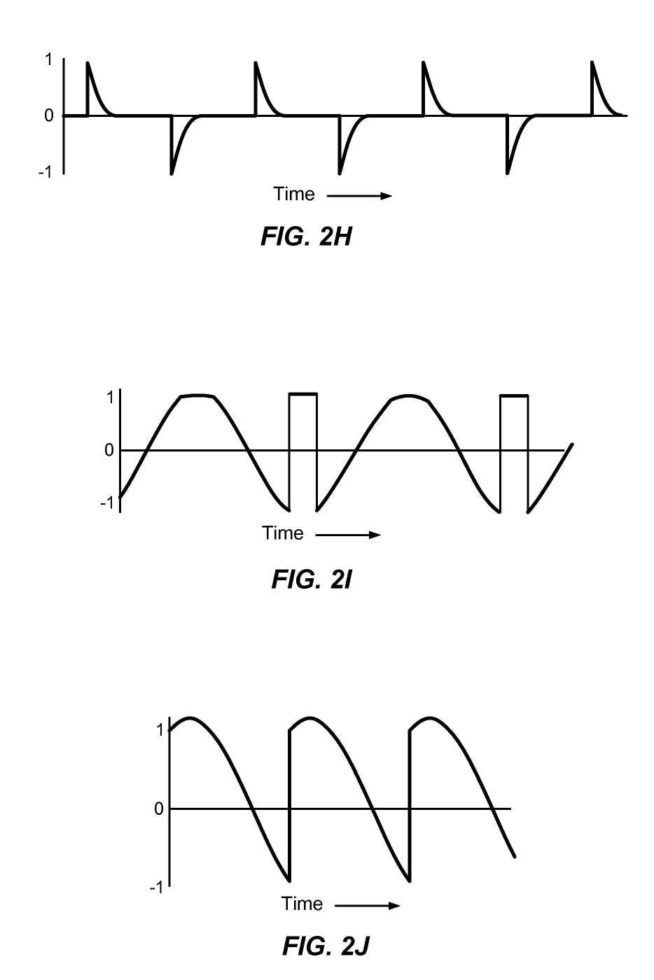

FIG. 2A is a definition of an ideal square wave for use with examples described herein. The discontinuous nature of a square wave, e.g. the value repeatedly jumps from 1 to −1 and then back again, may be created through the superposition of an infinite number of sine waves of appropriate frequency and amplitude.

FIG. 2B is a definition of an ideal sawtooth wave. The discontinuous nature of a sawtooth wave, e.g. the value repeatedly jumps from 1 to −1, may be created through the superposition of an infinite number of sine waves of appropriate frequency and amplitude.

FIG. 2C illustrates a variety of periodic functions that include “hard” discontinuities. Any of these audio waveforms, and/or any single pulse or portion therein containing at least one discontinuity, would be suitable for use as the basis for the generation of discontinuous audio signatures in a personal computing device.

FIGS. 2D-2J illustrate other examples of various functions which include “hard” discontinuities. With specific respect to FIG. 2D, a periodic function that includes “hard” discontinuities is illustrated. This audio waveform, and/or any single pulse or portion therein containing at least one discontinuity, would be suitable for use as the basis for the generation of discontinuous audio signatures in a personal computing device.

FIG. 2E is an illustration of a single pulse function that includes two “hard” discontinuities. This audio waveform contains two discontinuities and would be suitable for use as the basis for the generation of discontinuous audio signatures in a personal computing device.

FIG. 2F is an illustration of a periodic function that includes “hard” discontinuities. This audio waveform, and/or any single pulse or portion therein containing at least one discontinuity, would be suitable for use as the basis for the generation of discontinuous audio signatures in a personal computing device.

FIG. 2G is an illustration of a single pulse function that includes two “hard” discontinuities. This audio waveform contains two discontinuities and would be suitable for use as the basis for the generation of discontinuous audio signatures in a personal computing device.

FIG. 2H is an illustration of a periodic function that includes “hard” discontinuities. This periodic audio waveform, and/or any single pulse or portion therein containing at least one discontinuity, would be suitable for use as the basis for the generation of discontinuous audio signatures in a personal computing device.

FIG. 2I is an illustration of a periodic function that includes “hard” discontinuities. This periodic audio waveform, and/or any single pulse or portion therein containing at least one discontinuity, would be suitable for use as the basis for the generation of discontinuous audio signatures in a personal computing device.

FIG. 2J is an illustration of a periodic function that includes “hard” discontinuities. This periodic audio waveform, and/or any single pulse or portion therein containing at least one discontinuity, would be suitable for use as the basis for the generation of discontinuous audio signatures in a personal computing device.

FIGS. 3A through 3C are examples of periodic functions that include “soft” discontinuities. These waveforms can be referred to as “clipped” sine waves. These periodic audio waveforms, and/or any single pulses or portions therein containing at least one discontinuity, would be suitable for use as the basis for the generation of discontinuous audio signatures in a personal computing device. However, the amplitude and extent of the ringing that would result from the generation of these “softly discontinuous” audio waveforms would likely be less than that associated with the generation of an audio ,waveforms containing one or more “hard” discontinuities.

FIG. 4A illustrates the superposition of a “fundamental” sine wave with a 3rd harmonic. The result (as illustrated in the lower of the two graphs) is a rough approximation to a square wave.

FIG. 4B illustrates the superposition of a “fundamental” sine wave with respective 3^{rd} and 5^{th} harmonics. The result is a rough approximation to a square wave. However, because of the inclusion of an additional harmonic, this approximation to a square wave is more accurate than that illustrated in FIG. 4A.

In examples, a sine wave includes a single frequency. A sound wave approaching a sine wave may be approached by musical instruments such as tuning forks and flute tones. Such a waveform may be smoothly rounded everywhere with no sudden changes in direction. A collection of sine waves of different frequencies and sizes may be used to build other repetitive waveforms.

FIG. 4C illustrates a progressive superposition of a “fundamental” sine wave with an increasing number of its harmonics. The addition of each new harmonic improves the accuracy of the approximation to a square wave.

FIG. 4D illustrates a step-wise progressive superposition of a “fundamental” sine wave with an increasing number of its harmonics. The value of “K” indicates the number of sine waves (i.e. the number of fundamental and harmonic sine waves) that have been used to create each progressively better approximation to a square wave. After the superposition of 49 sine waves (i.e. a fundamental and 48 of its harmonics) “ringing” occurs at the edges of the discontinuities.

FIG. 5 illustrates an example square wave (and the discontinuities therein) which can be used as a basis for generation of audio by a personal computing device's sound-generation system. Note that the more significant ringing occurs after the discontinuity.

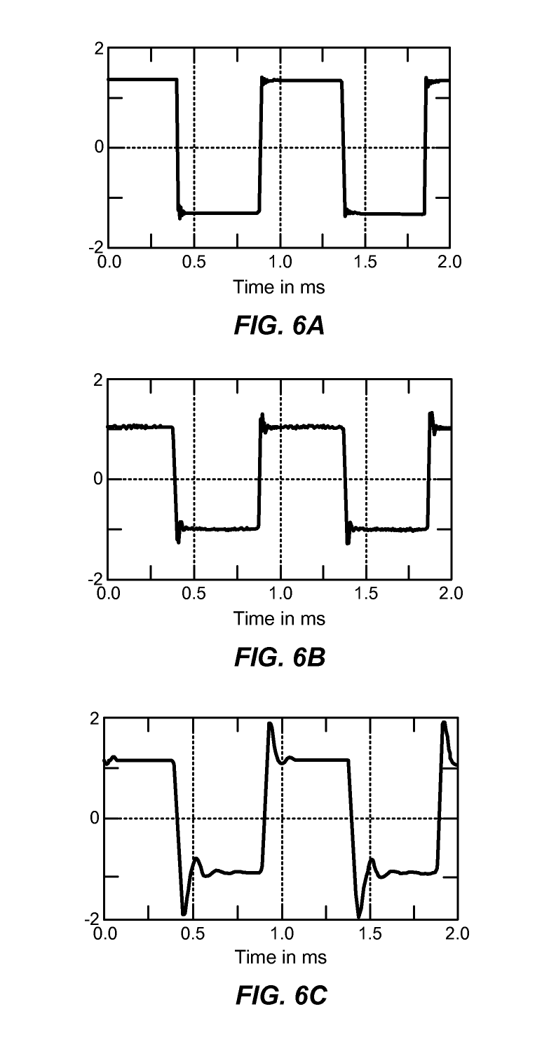

FIGS. 6A through 6C illustrate examples of audio generated by sound-generation systems of different computer systems, according to examples. The pattern, magnitude and extent of ringing may vary between individual personal computing devices.

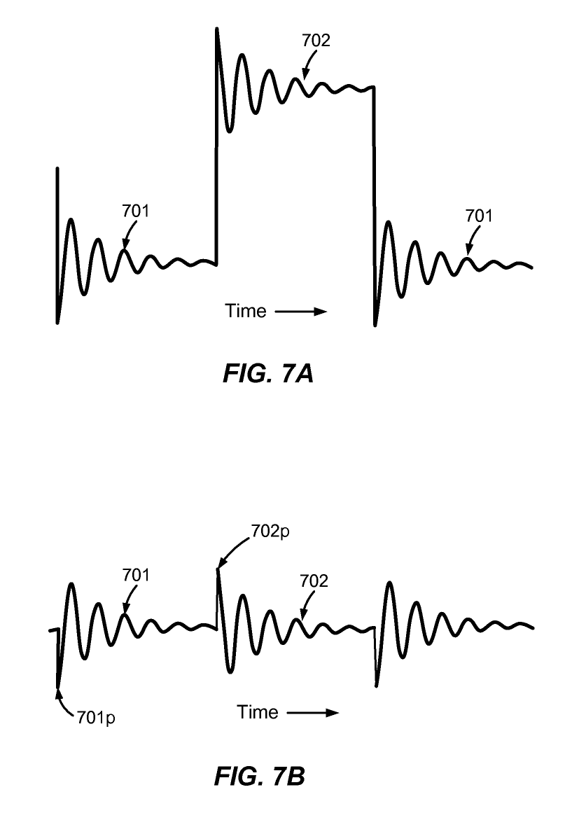

FIG. 7A illustrates an example audio signal generated by the sound-generation system of a personal computing device. Ringing follows each discontinuity in the square wave.

FIG. 7B illustrates an example of an audio output and system which can be generated by a personal computing device as that device plays a source audio waveform containing square waves. Note that the actual sound represents the oscillations 701 and 702, while omitting the DC offsets (the vertical spikes between the ring patters 701 and 702).

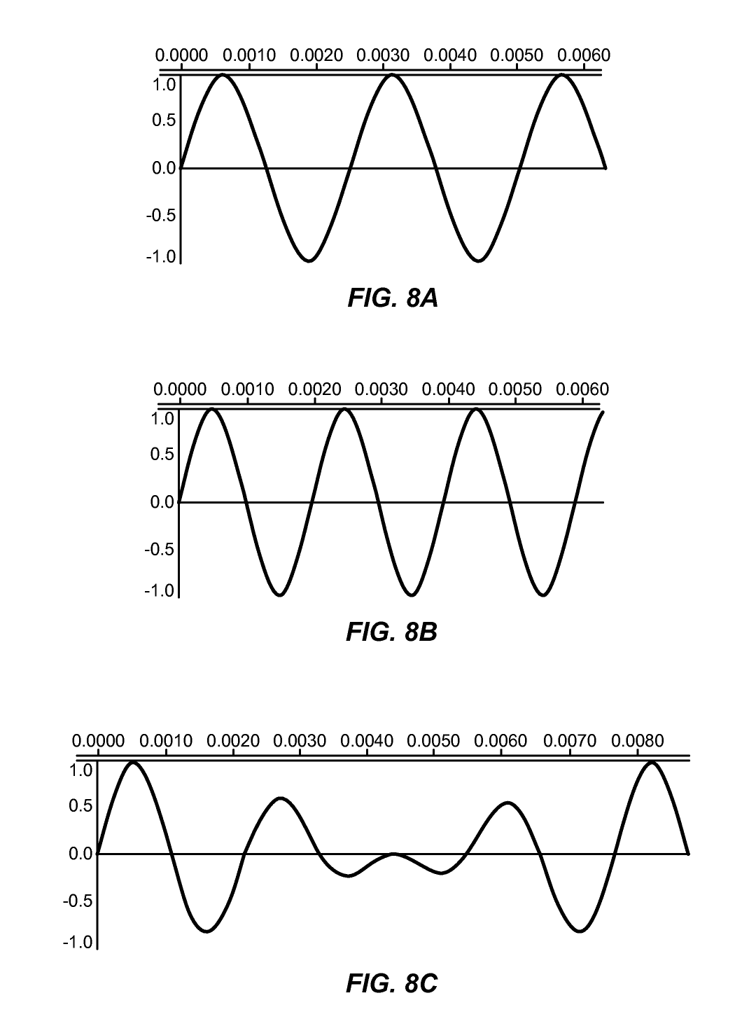

FIG. 8A illustrates an example 400 Hz sine wave at maximum (e.g., 100%) amplitude.

FIG. 8B illustrates an example 513 Hz sine wave at maximum (e.g., 100%) amplitude.

FIG. 8C illustrates an example waveform resulting from combination of a 400 Hz sine wave (at maximum amplitude) and a 513 Hz sine wave (at maximum amplitude). This kind of superposition of sine waves is what leads to the creation of the “ringing” pattern that follows a discontinuity in the audio generated by the sound-generation system of a personal computing device.

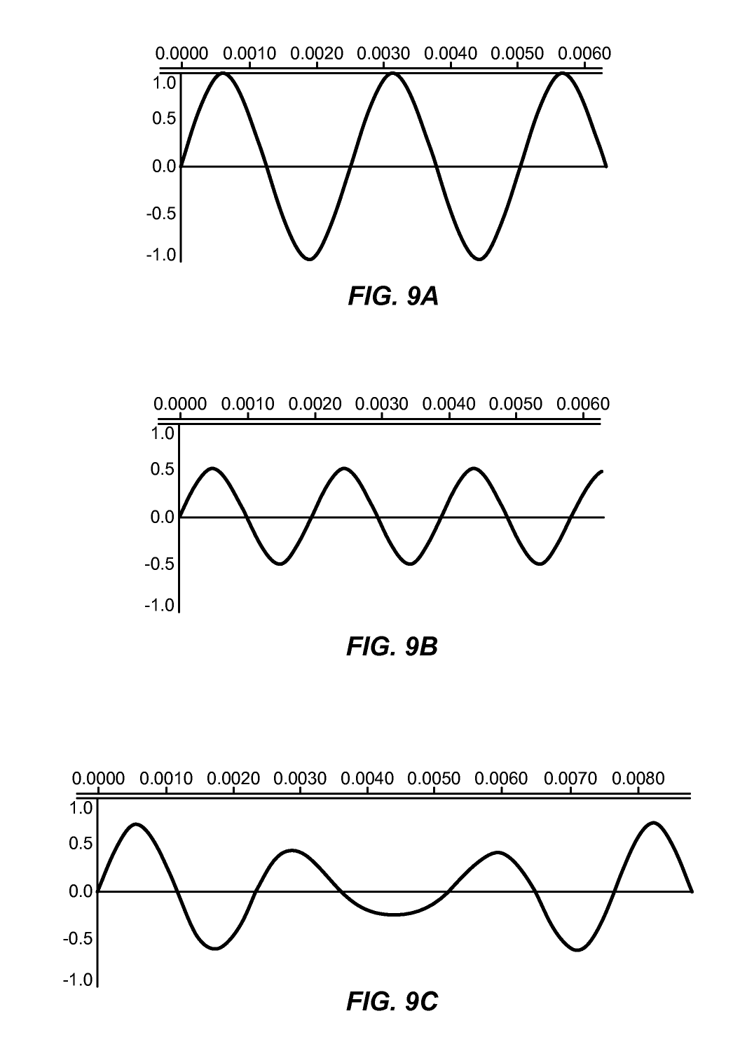

FIG. 9A illustrates an example 400 Hz sine wave at maximum (e.g., 100%) amplitude.

FIG. 9B illustrates an example 513 Hz sine wave at half maximum (e.g., 50%) amplitude.

FIG. 9C illustrates example waveforms resulting from combination of a 400 Hz sine wave (at maximum amplitude) and a 513 Hz sine wave (at 50% of maximum amplitude). The superposition of sine waves leads to the creation of the “ringing” pattern that follows a discontinuity in the audio generated by the sound-generation system of a personal computing device. As the combined waveform reflects the amplitudes (and phases) of all of the individual signals that are combined, the waveform illustrated in FIG. 9C may differ from other waveforms.

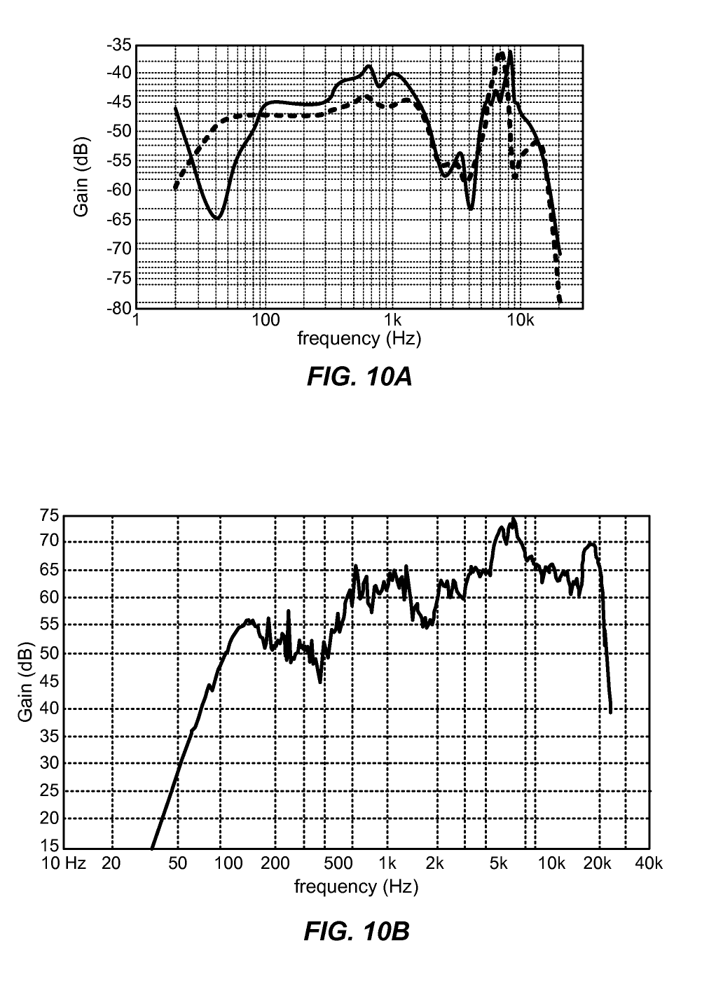

FIG. 10A illustrates a frequency responsivity as between multiple speakers. When attempting to play a source audio waveform with a specified frequency and amplitude (i.e. volume), each of the two speakers will output a unique volume (indicated as “Gain” along the y-axis). Each speaker generates a unique volume of audio in response to the playing of a source audio of a particular specified volume at a respective source audio frequency.

FIG. 10B illustrates an example frequency responsivity of a speaker (and the corresponding sound generation system) for an actual personal computing device. In this case, the personal computing device is a “Dell Inspiron 9300”™ laptop computer.

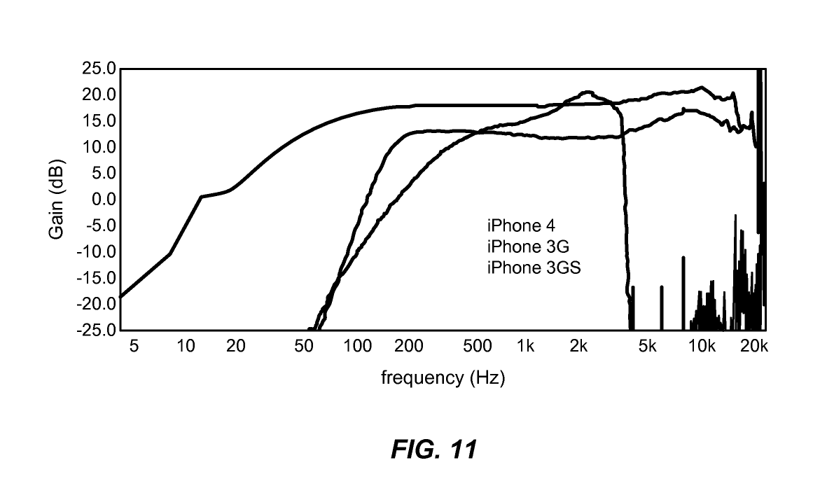

FIG. 11 illustrates an approximate degree to which the built-in microphones (as opposed to the microphones in headsets) of different devices are sensitive to sounds of various frequencies. Each microphone has a unique sensitivity profile, meaning that the amplitude that each device (e.g., iPhone™ device) will record, and specify in a digitized audio file, for sounds of any specific frequency (within the range of frequencies illustrated where the sensitivity is non-zero) will be unique. Additionally, even with respect to the same type of iPhone™ (e.g. with respect to iPhone 4s™), each individual iPhone™ will record, and specify in a digitized audio file, a unique amplitude (within the limit imposed by the available number of bits available within the audio format used) for sounds of any specific frequency.

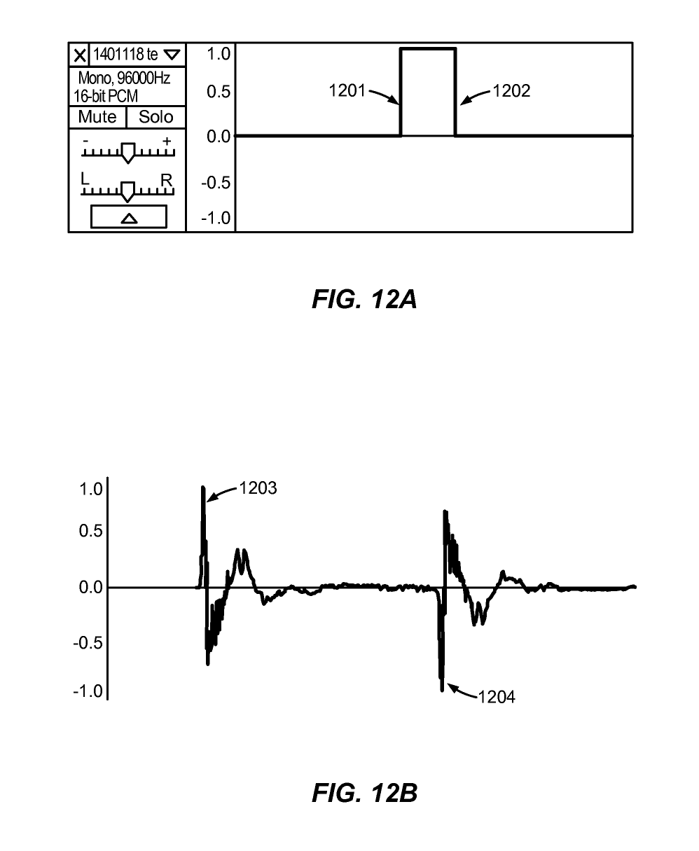

FIG. 12A illustrates an audio waveform suitable for use when generating a discontinuous audio signature for a personal computing device. This source audio waveform contains a single square wave. That square wave contains two discontinuities. One discontinuity 1201 constitutes a rising-edge where the value of the amplitude changes instantaneously from 0 to 1.0. The other discontinuity 1202 constitutes a falling-edge where the value of the amplitude changes instantaneously from 1.0 to 0.

FIG. 12B illustrates a recorded audio waveform of when a personal computing device records the sound generated by its simultaneous playing of a source audio waveform, such as illustrated in an example of FIG. 12A. The audio recording of FIG. 12B illustrates an example of the discontinuous audio signature of a personal computing device.

Ringing pattern 1203 corresponds to the playing of the rising edge 1201 of the square wave illustrated in FIG. 12A. Ringing pattern 1204 corresponds to the playing of the falling edge 1202 of the square wave illustrated in FIG. 12A. The ringing pattern 1204 resulting from the playing of the falling edge 1202 of the square wave is substantially identical to the ringing pattern 1203 resulting from the playing of the rising edge 1201 of the square wave, with the notable exception that the ringing pattern 1204 is, with respect to the vertical axis (i.e. amplitude), a mirror image (i.e. of opposite polarity) to that of 1203.

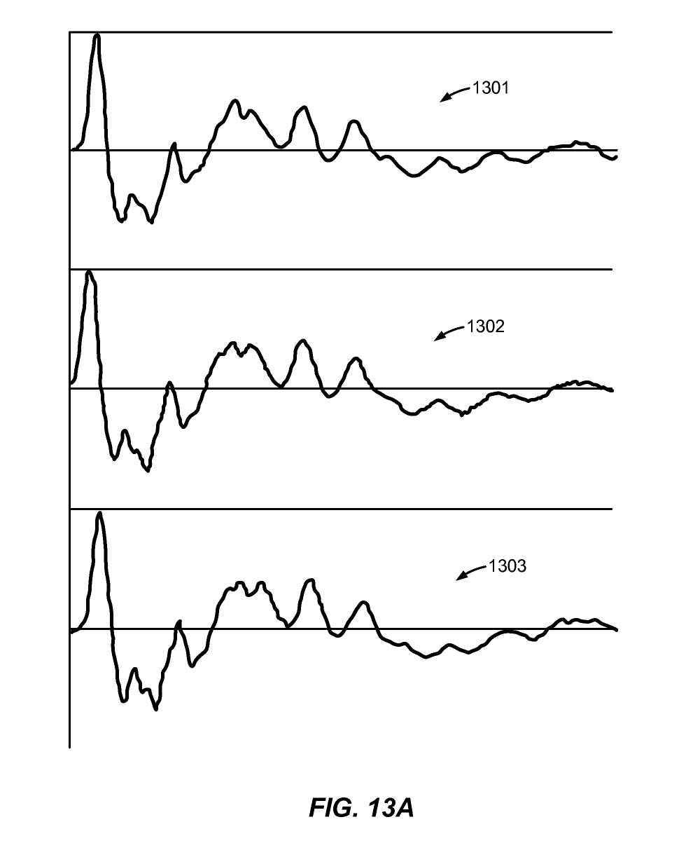

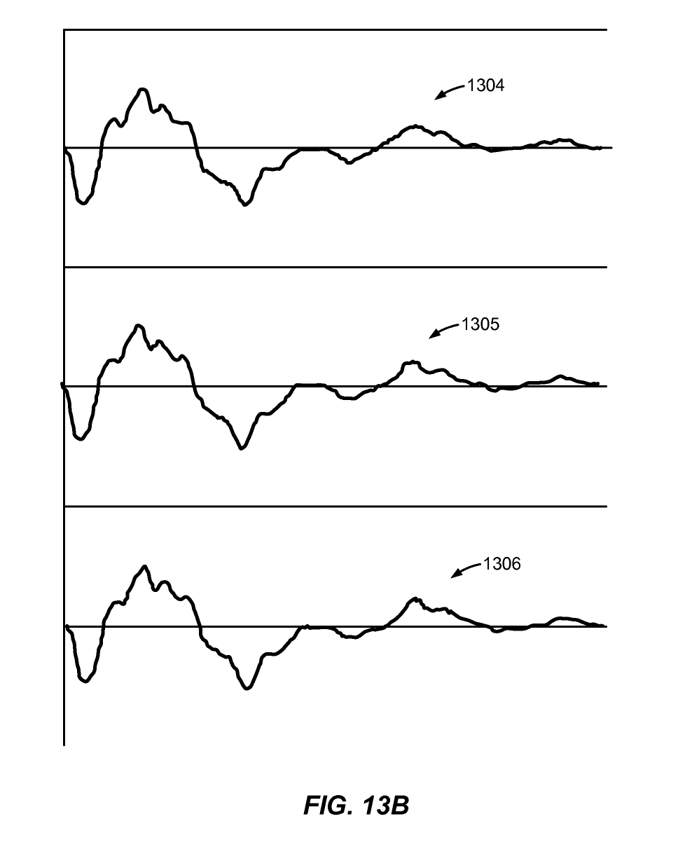

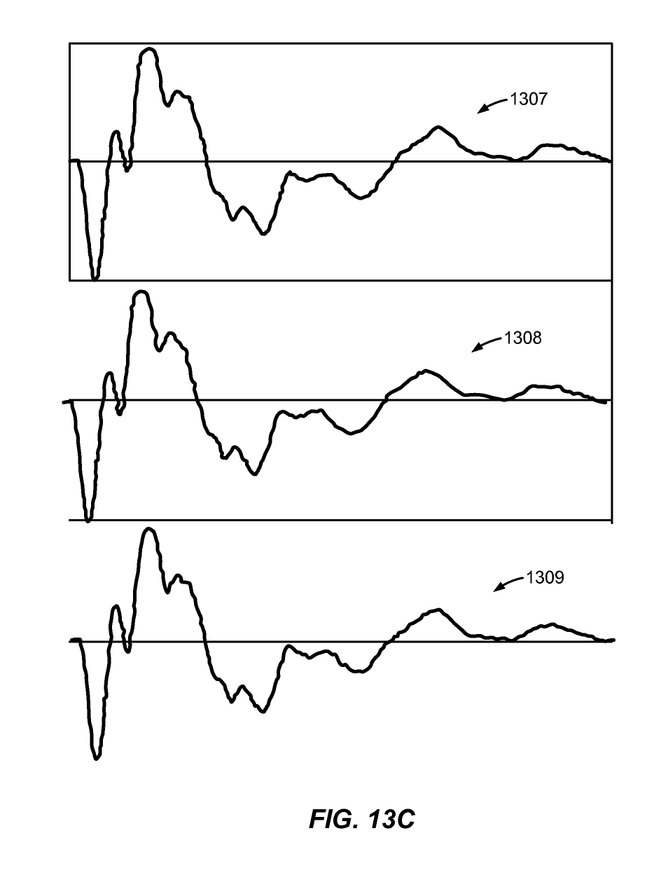

FIG. 13A illustrates additional examples of actual discontinuous audio signatures obtained from an example device. Three discontinuous audio signatures (1301, 1302 and 1303) were obtained from a particular personal computing device (e.g., an iPhone™ device designated as “test unit 1”). Each waveform corresponds to the ringing pattern arising from the playing and recording on the device of the rising edge of a square wave (such as associated with the audio waveform illustrated in FIG. 12A).

Since the rising and falling edges of the source audio square wave have vertically-reversed but otherwise substantially identical ring patterns (as discussed above in relation to FIG. 12B), for at least some devices it is sufficient to use only one ring pattern to define the discontinuous audio signature.

In the illustration of FIG. 13A, the discontinuous audio signatures were obtained during separate trials with the “test unit 1” personal computing device. While the signatures are not identical, they are sufficiently similar to each other, and sufficiently distinct from the signatures associated with other devices, to be used to identify the computing device.

In an alternative, with reference to FIGS. 13B and 13C, significant differences may exist between the sets of discontinuous audio signatures illustrated by FIGS. 13A, 13B and 13C. These figures provide examples of discontinuous audio signatures corresponding to three different personal computing devices referred to herein as test units 1, 3 and 6, respectively.

FIG. 13B illustrates additional examples of actual discontinuous audio signatures (1304, 1305 and 1306) obtained from another example device (e.g., an iPhone™ designated as “test unit 3”).

FIG. 13C illustrates additional examples of discontinuous audio signatures (1307, 1308 and 1309) obtained from another example device, according to another example (e.g., an iPhone™ designated as “test unit 6”).

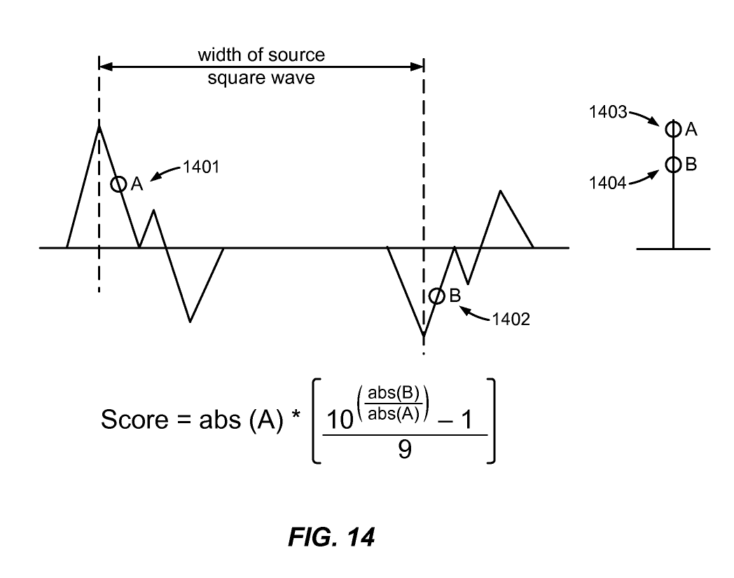

FIG. 14 illustrates an example method for automatically locating a pair of vertically-inverted signature waveforms such as illustrated in FIGS. 12B, 13A, 13B and 13C.

A digital audio file may be recorded by a personal computing device while that same computing device plays a discontinuous source audio waveform (e.g., a single square wave). That digital audio file can then be analyzed. For example, the file can be analyzed after it is uploaded to a server.

The distance (i.e. the number of audio samples) between the rising and falling edges of the square wave in the source audio can be determined. Each pair of samples in the recorded audio that is separated by the same amount (or by a number of samples in the recorded audio that corresponds to the same difference in time between the rising and falling edges of the source square wave) is processed. Since a ring pattern and its vertically-inverted complementary pattern may not be identical, an algorithm may be utilized to compensate for those differences. For example, in evaluating a particular pair of audio samples, e.g. “A” (1401) and “B” (1402), it is determined that the samples have respective amplitudes (i.e. volumes or voltages) of 1403 and 1404. A “score” for a pair of audio samples may be determined by applying an indicated equation.

According to some examples, a score is determined for every pair of audio samples, separated by the requisite number of samples, across the entire recorded audio file. A range can then be identified of contiguous scores for which the sum is maximal. The width of the range can be arbitrary, but is best selected so as to be of approximately the same length as the median, majority and/or longest ring pattern expected. In some examples, the same range width should be used for all discontinuous audio signatures that will be analyzed and compared for the purpose of identifying and/or differentiating personal computing devices.

FIG. 15A illustrates an example method for utilizing a matrix signature representation for transforming a discontinuous audio waveform (e.g. of the type illustrated in FIGS. 12B, and 13A-C) into a format that is suitable for comparison with other similarly transformed discontinuous audio waveforms. The peaks and valleys (i.e. maxima and minima) of the curve defined by the waveform of the discontinuous audio signature are identified (e.g. points “A” through “G” in FIG. 15A). In the illustration of FIG. 15A, the width of the range (discussed in FIG. 14) is 256 (i.e. the x axis goes from 0 to 255).

A matrix can be defined where the x-axis is the same length as the width of the signature waveform (e.g. 256 samples long), with the y-axis extends equal distances from the x-axis. In an embodiment, the exact distances of the x- and y-axes are greater than the maximum distance between any peak (or valley) and its neighboring valleys (or peaks).

In utilizing the matrix, for every peak and valley (e.g., the primary peak or valley) in the waveform, the appropriate position on the x axis (e.g., the x-axis coordinate that corresponds to the relative position of that peak or valley with respect to the origin, which is deemed to be the first peak or valley in the signature waveform. is used. A count is incremented at the matrix position(s) at the x-coordinate and y-coordinate(s) that correspond to the distance 1501 between the primary peak or valley and each of its neighboring extremes (i.e. valleys if the primary extreme is a peak, or peaks if the primary extreme is a valley). This is repeated for each extreme neighboring the primary extreme wherein the amplitudes (or “gains”) of those extremes grow in their extremity (i.e. where the valleys become smaller, or more negative, and where the peaks become greater, or more positive).

With respect to the extremes to the left of the primary extreme, matrix cells are incremented above the x-axis (e.g., where the distance, or y-coordinate, represents the positive distance between the two extremes). With respect to extremes to the right of the primary extreme, the matrix cells below the x-axis (i.e. where the distance, or y coordinate, represents the negative distance between the two extremes) are incremented.

FIG. 15B illustrates the matrix signature representation of a set of discontinuous audio signature waveforms, according to another example.

FIG. 15C illustrates the matrix signature representation of a set of discontinuous audio signature waveforms, according to another example.

FIG. 15D illustrates the matrix signature representation of a set of discontinuous audio signature waveforms, according to an example. In the example of FIG. 15D, each of the test units 1, 3 and 6 are characterized by differences between the matrix signature representations. By comparing the degree to which counts in the cells of one matrix signature representation overlap those in the cells of another matrix signature representation, i.e. their relative intersection, the degree of similarity between the discontinuous audio signatures of two personal computing devices may be quantified. Furthermore, this information may be used to determine the likelihood that two sets of signature data which were believed to be obtained from the same personal computing device did, in fact, originate from the same device.

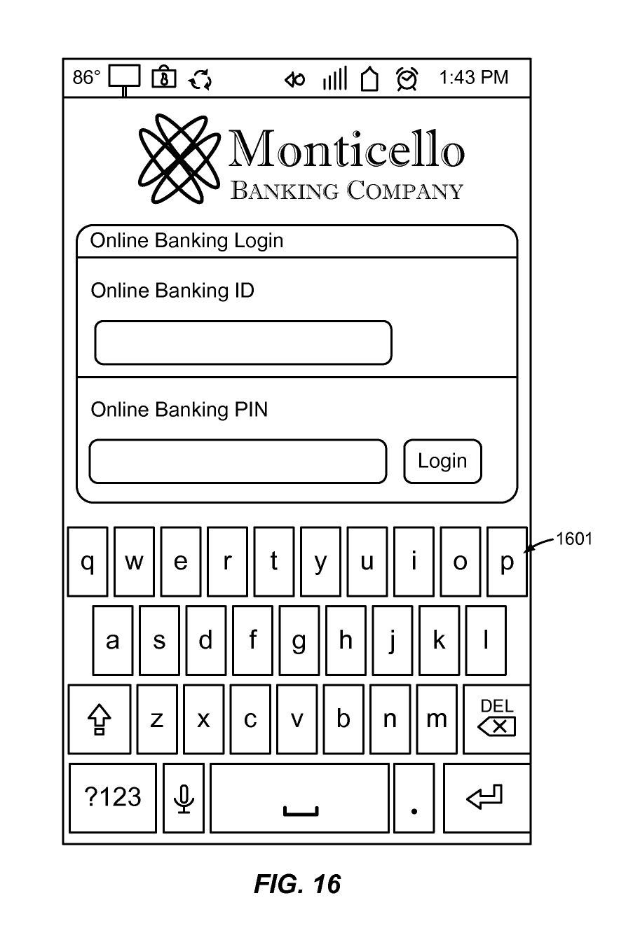

FIG. 16 illustrates an example of an implementation with use of one or more embodiments. An example application can run on a mobile phone. When the user of the phone attempts to utilize the bank application in order to transfer money from one of his accounts, he first enters his banking ID and PIN. As he does so, he presses his finger against points on the screen of his phone that correspond to keys 1601 on a keyboard. Each time he presses one of these virtual keys, the application generates a sound (e.g., “click” sound) to provide the user with confirmation that a key has been pressed.

In an alternative to a “click” sound for key-press confirmations, the application could instead play a discontinuous audio waveform, such as the square wave discussed and illustrated above. Each time the waveform is played, and substantially simultaneously, the application may also record the sound that is actually generated. In an example, the application may also record background noises.

Following each recording of the playback of the sound (e.g., discontinuous source audio waveform), the application sends a resulting recorded audio file back to the bank's servers (e.g., servers to which the bank application is attempting to connect to; or servers which the bank application has already connected to). The bank server (e.g., via an application operating on the bank server) receives the discontinuous audio signature waveform(s) (e.g., a pair of waveforms as illustrated in FIG. 14). The signature waveform in each uploaded recording of the phone's playback of the discontinuous source waveform is transformed into a representation.

The bank's server then retrieves (e.g., via the application operating on the bank's server), from a database, the reference representation of the indicated phone's discontinuous audio signature. A reference representation may have been generated in various ways. For example, the reference representation may have been generated at the time that the application was installed on the phone and/or the first time the application was used. In such an example, login validation checks could be used to ensure the authenticity of the user; for example, to verify a banking customer ID specified by the user.

If the most recently uploaded discontinuous audio signature recordings, and/or the transformation(s) thereof, are sufficiently similar to the equivalent reference recordings and/or transformation(s) found in the database, then the bank server determines that it is at least relatively safe to authorize the customer's requested transaction(s). In implementations, the bank's server may additionally or alternatively use other protocols to determine whether there is an acceptable level of risk to execute the customer's requested transaction(s). For example, the bank's server may utilize a less stringent identification validation (e.g. answers to secret questions) protocol.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for identifying a personal computing device in which a discontinuous source waveform is played on a personal computing device resulting in the creation, by the device, of a sound; wherein the created sound is recorded resulting in the creation of a recorded audio waveform; and the recorded audio waveform, and/or some of its attributes and/or characteristics, are used to uniquely identify the device.

2. The method of claim 1 in which the resulting sound is recorded by the same personal computing device that creates the sound, and the

[symbol]

3. The method of claim 1 in which the discontinuous source audio waveform includes a “square wave.”

4. The method of claim 1 in which the discontinuous source audio waveform includes a “sawtooth wave.”
